(19) United States
(12) Patent Application Publication
(10) Pub. No.: US 2016/0292644 A1
(43) Pub. Date: Oct. 6, 2016

(54) DATA DRIVEN HIRING FILTER APPARATUS AND METHOD

(71) Applicant: SurePeople LLC, ARLINGTON HEIGHTS, IL (US)

(72) Inventor: NIKO DRAKOULIS, ARLINGTON HEIGHTS, IL (US)

(21) Appl. No.: 15/090,269

(22) Filed: Apr. 4, 2016

Related U.S. Application Data
(60) Provisional application No. 62/142,780, filed on Apr. 3, 2015.

(51) Int. Cl. G06Q 10/10

(52) U.S. Cl. CPC G06Q 10/1053

(57) ABSTRACT

A data driven hiring filter assessment apparatus and method uses trait assessments to compares factors based on two individual's assessment. The personality factors are determined by a plurality of assessments for both candidates for a comparison.

### CROSS REFERENCE TO CO-PENDING APPLICATION

This application claims priority benefit to the Apr. 3, 2015 filing date of co-pending U.S. Provisional Patent Application Ser. No. 62/142,780 filed in the name Niko Drakoulis as inventor of a “Data Driven Talent Management and Talent Acquisition Apparatus and Method”, the entire contents of which are incorporated herein in its entirety.

### BACKGROUND

The present data driven hiring filter apparatus and method relates, in general, to trait assessment tools.

Successful businesses require a motivated team of employees and administrators working toward a common business goal. However, every person has different traits, motivation, intelligence, and other personality characteristics which make team interaction and achievement of business goals a hit or miss prospect at best.

### SUMMARY

The apparatus and method for company candidates for hiring based on a measurement of an individual's emotional intelligence, relational intelligence and team intelligence by analyzing multiple unique traits based on a plurality of attributes. Assessing these attributes in potential employee candidates enables the business administrator to better understand the candidate's personalities, strengths, growth opportunities and capacities.

In one aspect, the method for generating an individual's personality assessment data includes coupling memory by a computer processor through a network to individual processors administering an assessment through the individual processors to individuals to determine an individual's personality assessment data and analyzing the assessment data by the computer processor and generating an assessment report comparing characteristics of different individuals.

The method generates side by side comparison of one of the individuals to the other individual or to an existing employees or model employee assessments.

The apparatus includes a computer processor assessing a memory storing an assessment test is couples to at least one individual processor coupled through a network and a digital display is coupled to the at least one individual processor for displaying a comparison of multiple assessments.

### BRIEF DESCRIPTION OF THE DRAWING

The various features, advantages and other uses of the present invention will become more apparent by referring to the following detailed description and drawing.

FIG. 1 is a block diagram of the components of the data driven assessment apparatus;

FIGS. 2A and 2B show a flow diagram of the business administrator login procedure for the data driven assessment method.

FIGS. 3A and 3B show a flow diagram of the business dashboard.

FIGS. 4A and 4B show a flow diagram of a business request for PRISM LENS™ assessment.

FIG. 5 is a flow diagram of a business sequence to take a PRISM LENS™ assessment.

FIG. 6 is a flow diagram of an individual sign up procedure for the data driven assessment apparatus and method.

FIGS. 7A and 7B show a flow diagram of the individual login sequence.

FIGS. 8A and 8B show a flow diagram of the individual dashboard of the present apparatus and method.

FIGS. 9A and 9B show a flow diagram of an individual request for a PRISM LENS™ assessment.

FIG. 10 is a flow diagram of the process for an individual to take a PRISM LENS™ assessment.

FIGS. 11A-11I are pictorial representations of sample assessment questions.

FIGS. 12A-12D show a pictorial representation of an assessment output depicting an individual's personality characteristics.

FIGS. 13A-13D show a pictorial representation of a personality under pressure assessment results of an individual.

FIGS. 14A-14C show a pictorial representation of a processing blueprints assessment results of an individual.

FIGS. 15A-15C show a pictorial representation of a motivation assessment results of an individual.

FIGS. 16A and 16B show a pictorial representation of a conflict management assessment results of an individual.

FIG. 17 is a pictorial representation of a fundamental need assessment results of an individual.

FIGS. 18A and 18B show a pictorial representation of a decision making assessment results of an individual.

FIGS. 19A and 19B show a pictorial representation of a primary learning style assessment results of an individual.

FIGS. 20A and 20B show a pictorial representation of the graphics and charts depicted in FIGS. 12A-19B.

FIGS. 21A-21C show a sequence diagram of the business hiring filter.

FIGS. 22A-22D show a pictorial representation of a side by side assessment report of two candidates.

### DETAILED DESCRIPTION

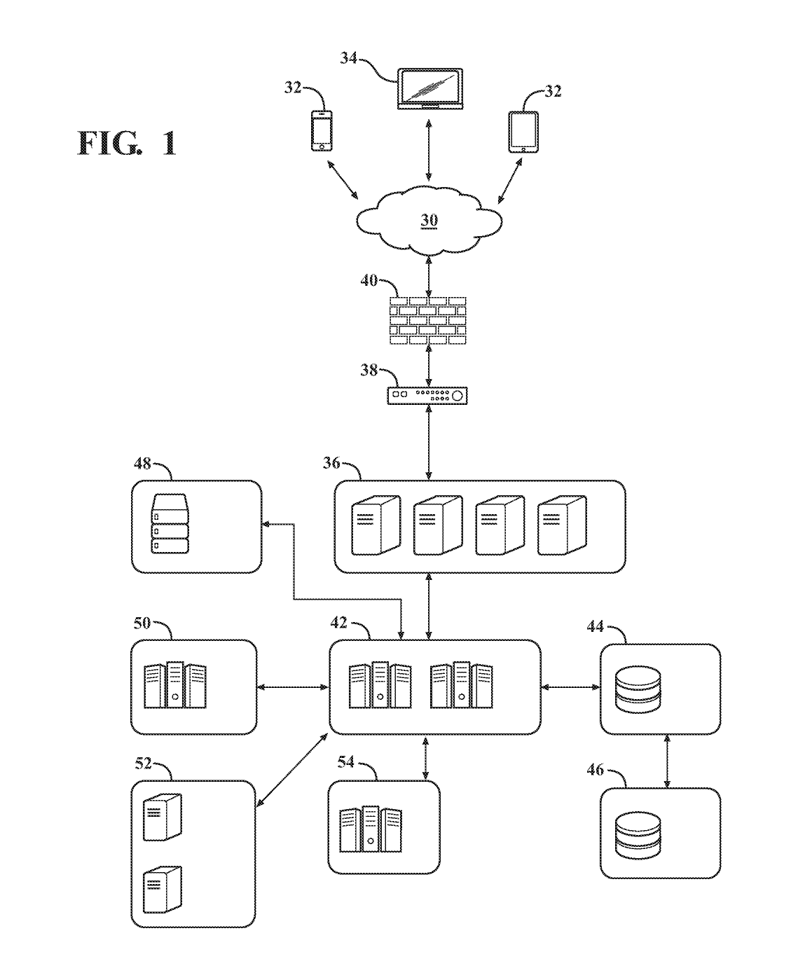

FIG. 1 depicts a cloud-based apparatus using a network, such as the worldwide web 30, for interaction between employers and employee via smartphones 32 and computers 34 to acquire employee assessment information, as well as reporting the results of such information to business management or to the individual.

As shown in FIG. 1, the apparatus, by example, includes a computer processor, which can be in the form of one or more web servers 36 connected to the worldwide web 30 through a load balancer 38 and a firewall 40. The web servers 36 communicate with one or more application servers 42. The application servers 42 communicate with database servers 44 and backup database servers 46, as well as data storage servers 48, a payment gateway server 50, a third party content services server 52 and CMS servers 54 (central management servers).

The present apparatus and method provide assessment-related reports to both business management and employees. The business side of the apparatus and method will first be described.

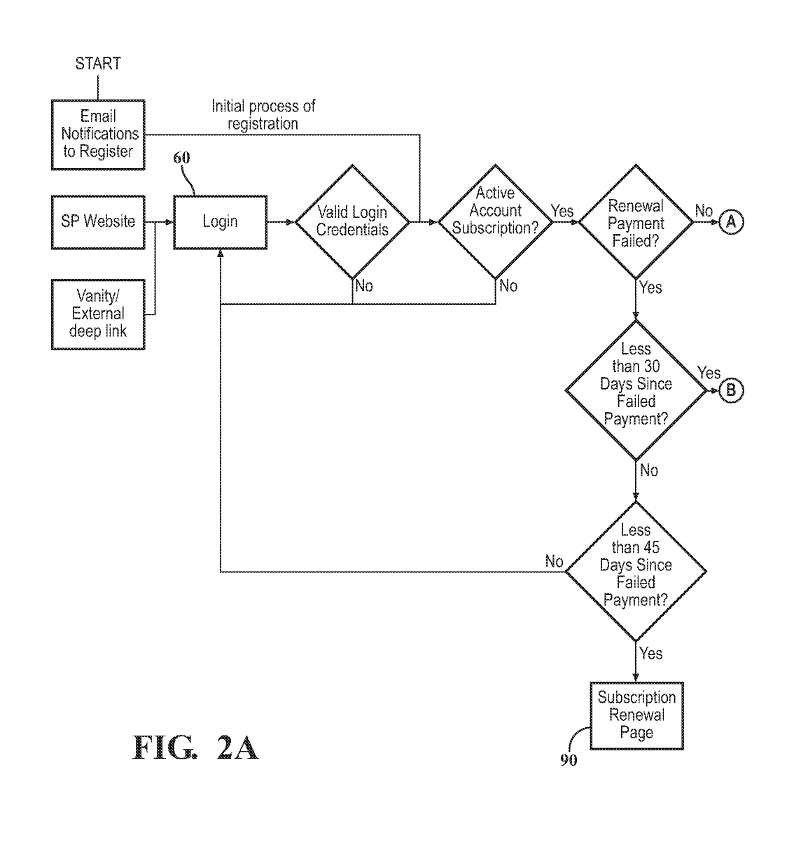

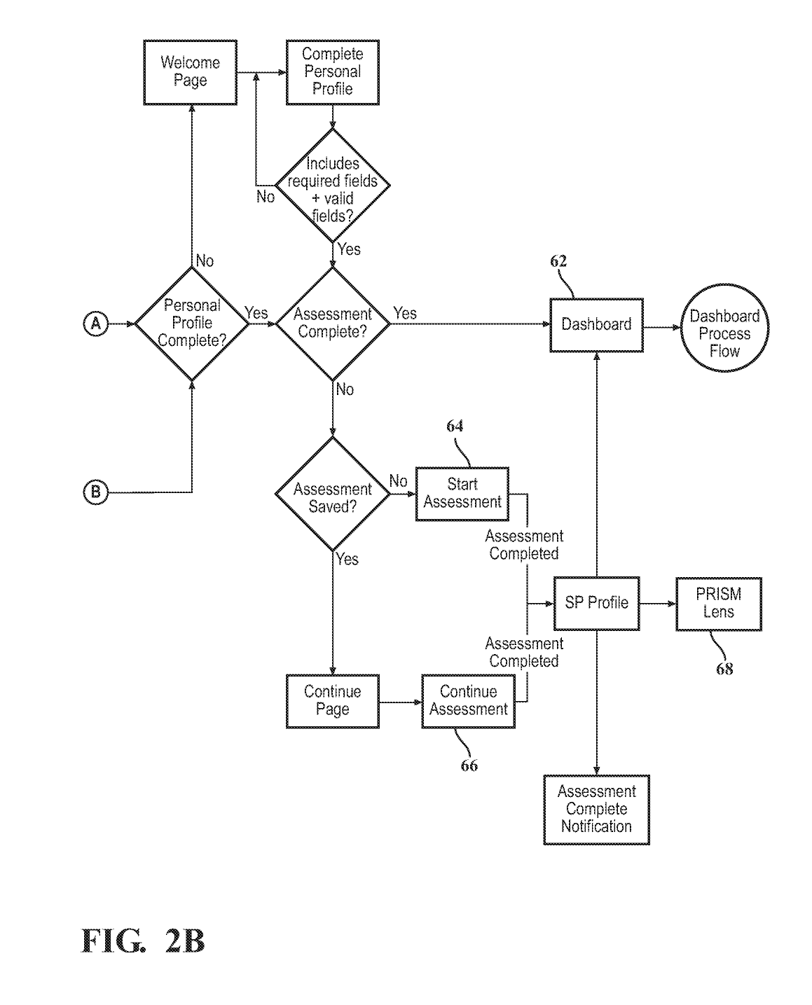

A business administration portion of the apparatus and method is shown in FIGS. 2A-11I and is accessible by at least one or more individual processors, such as a smartphone 32 or a computer 34 at a business site through the worldwide web 30 to the central computer processor system shown in FIG. 1.

As shown in FIGS. 2A and 2B, a business administrator can log-in in step 60 to open or access an assessment account. Such accounts include business profiles, subscription renewal services, etc. A dashboard 62 displayed on a computer monitor at the business site allows access by the business administrator to various parts of the employee assessment apparatus and method, including starting an assessment in step 64, continuing an assessment 66, and using the assessment results to create an employee profile in step 68.

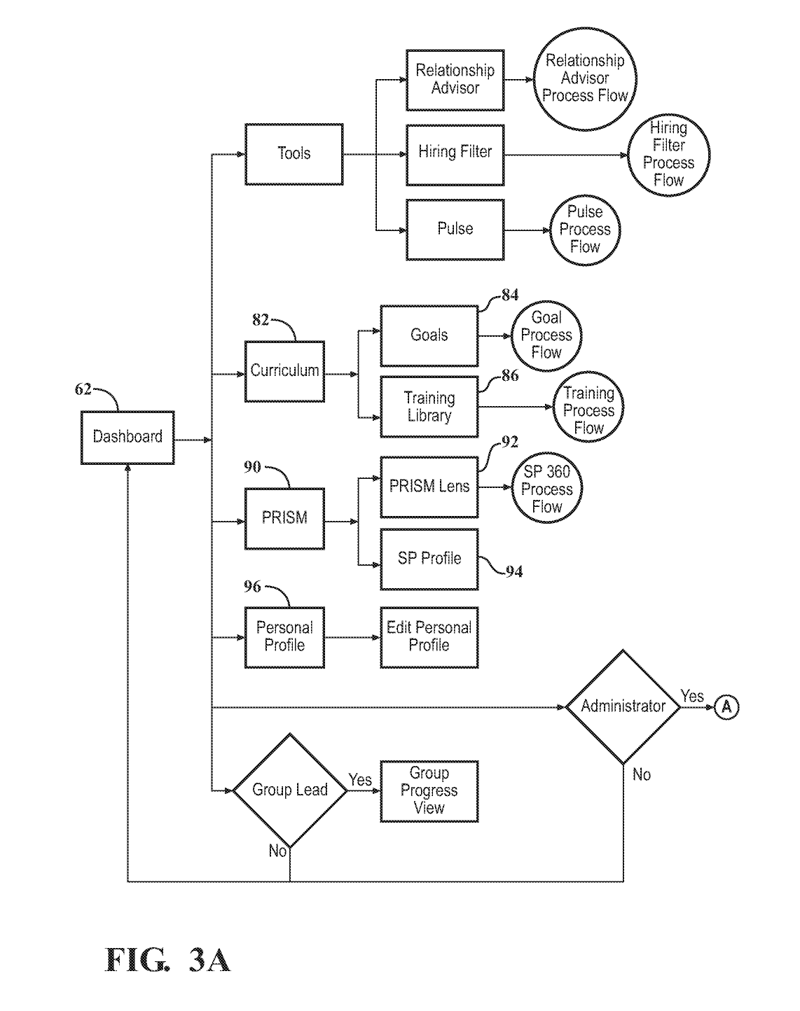

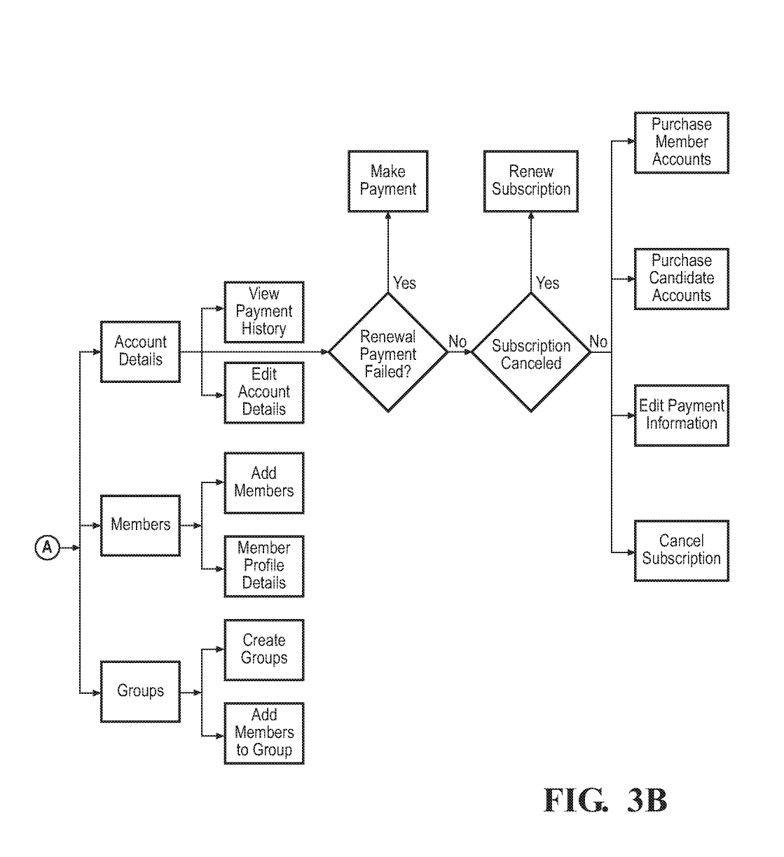

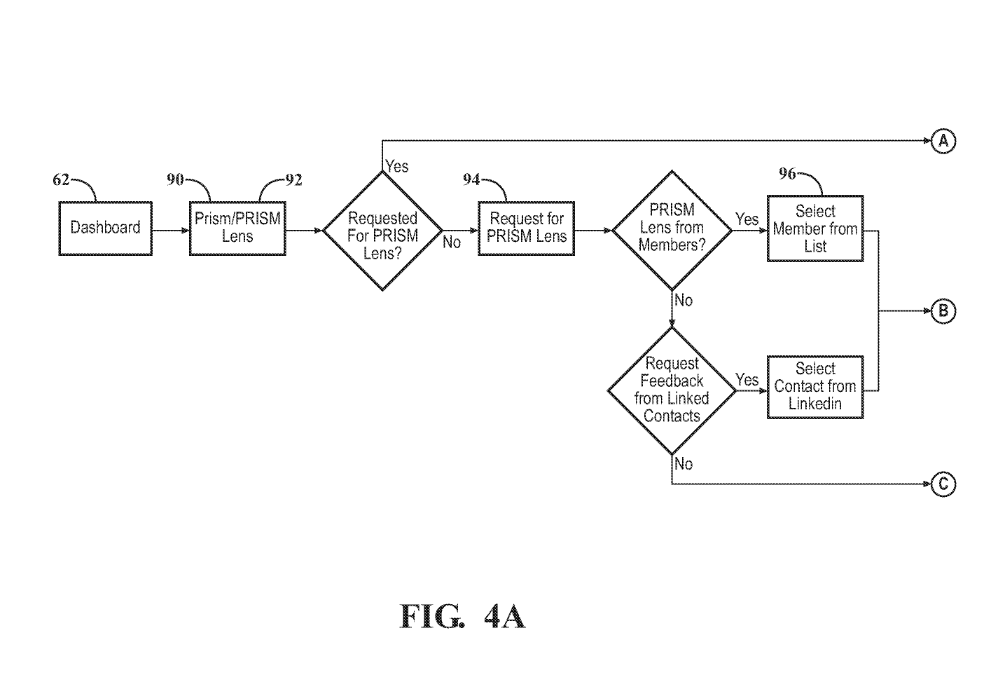

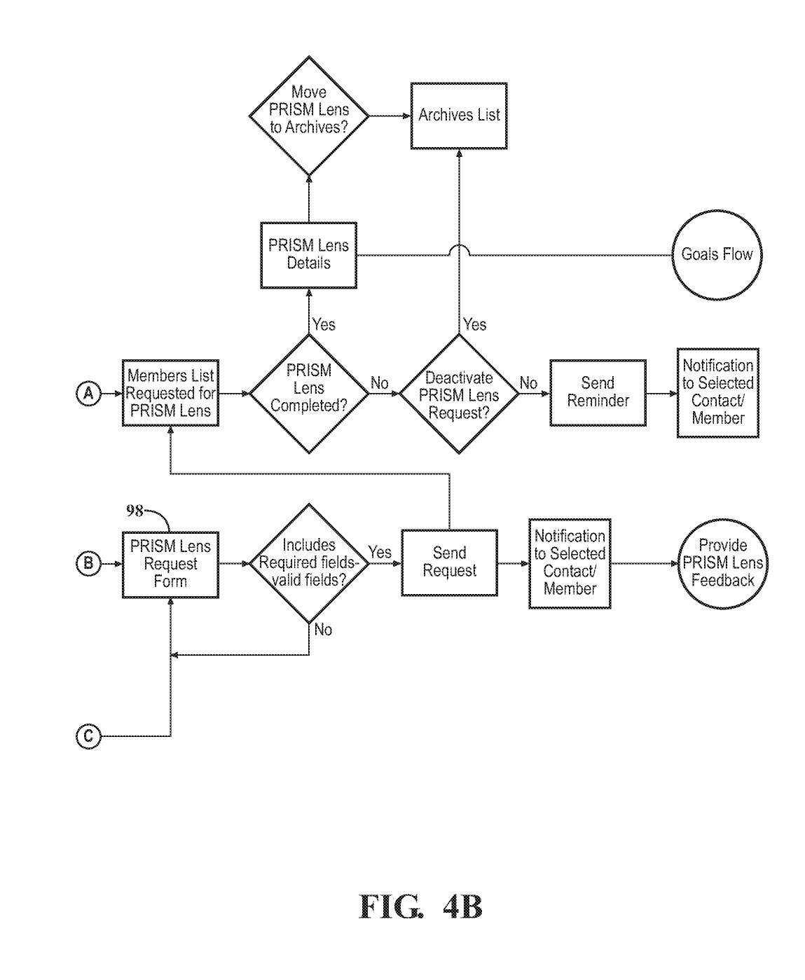

The dashboard 62, shown in FIGS. 3A and 3B, also allows access to various assessment or module features, such as a knowledge center 86. The dashboard 62 allows selection of a PRISM LENS™ module 92 allowing access to assessments 92 by an individual's peers and/or manager, or other individuals see FIG. 4, as well as to employee profiles 94. The dashboard 62 also allows access to a personal profile module 96 allowing the business administrator to edit the personal profile of any employee.

The dashboard 62 also provides additional versatility for the business to make payments as well as for the individual selected by the business or an outside individual to take an assessment 90. As shown in FIGS. 3A and 3B, a business administrator may assess account details 87 and make payments 89 in a number of different ways, such as all at once, periodic, automatically renewable, etc.

The business administrator may also authorize an individual selected by the business administrator to take an assessment test 90 to select, either at the businesses' or the individual's preference, to take all seven assessments of the PRISM™ assessment test 90 at one time, one at a time, in any partial sequence of less than the seven assessment, as well as providing a date deadline for completing all of the of the PRISM™ 90 assessment. In some instances, a business may not require all seven module of the PRISM™ 90 assessment described hereafter, in which case the business may direct an individual to take only selected assessments which are than presented to the individual. In the latter case, the individual may still have the preference to take all or some of the selected assessments at over a one-time preset time period etc.

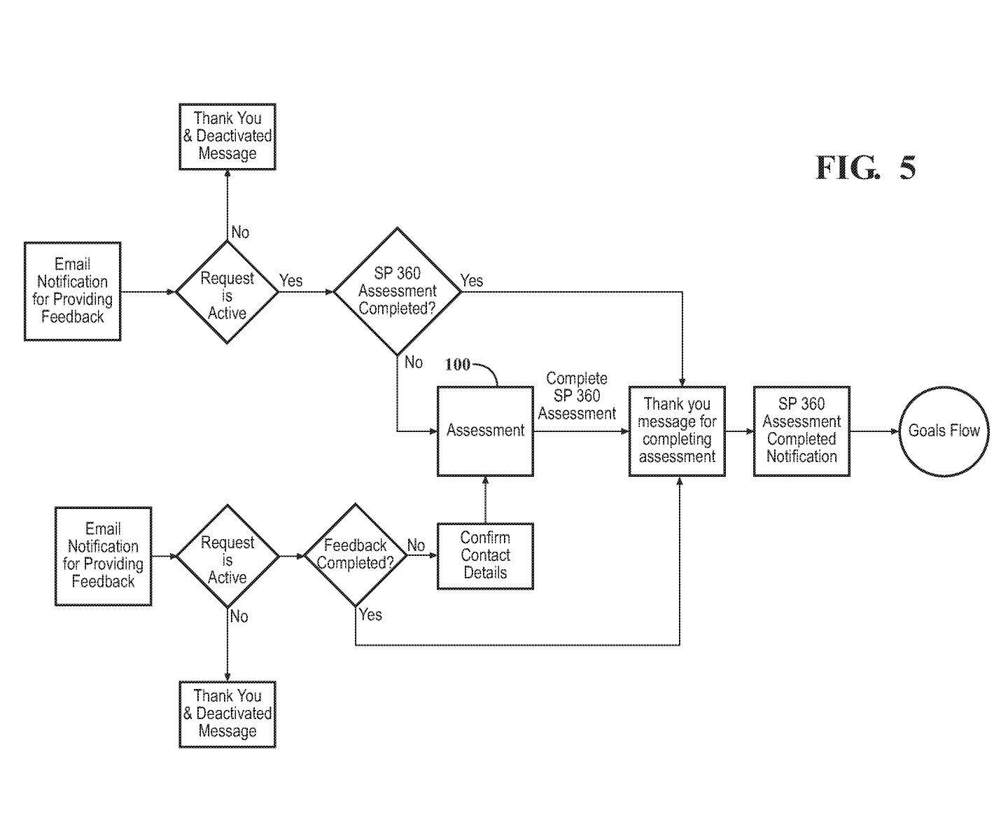

In the business mode, shown in FIGS. 4A, 4B, and 5, an administrator and/or employee may submit a request for an individual, such as an employee or non-employee, to take a PRISM LENS™ assessment 92 on another individual.

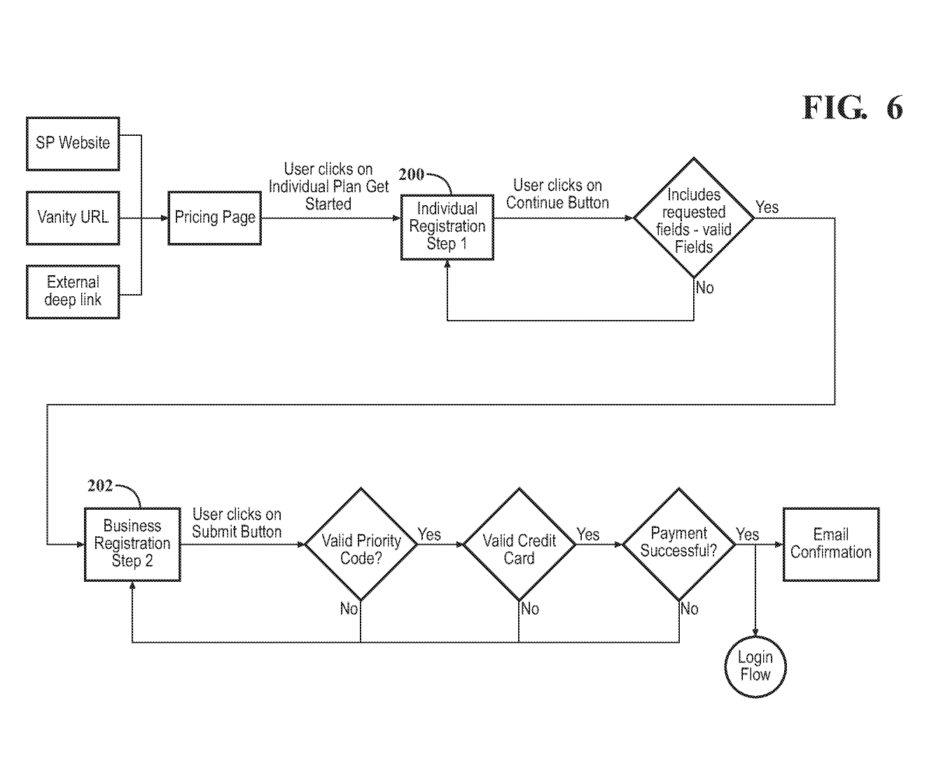

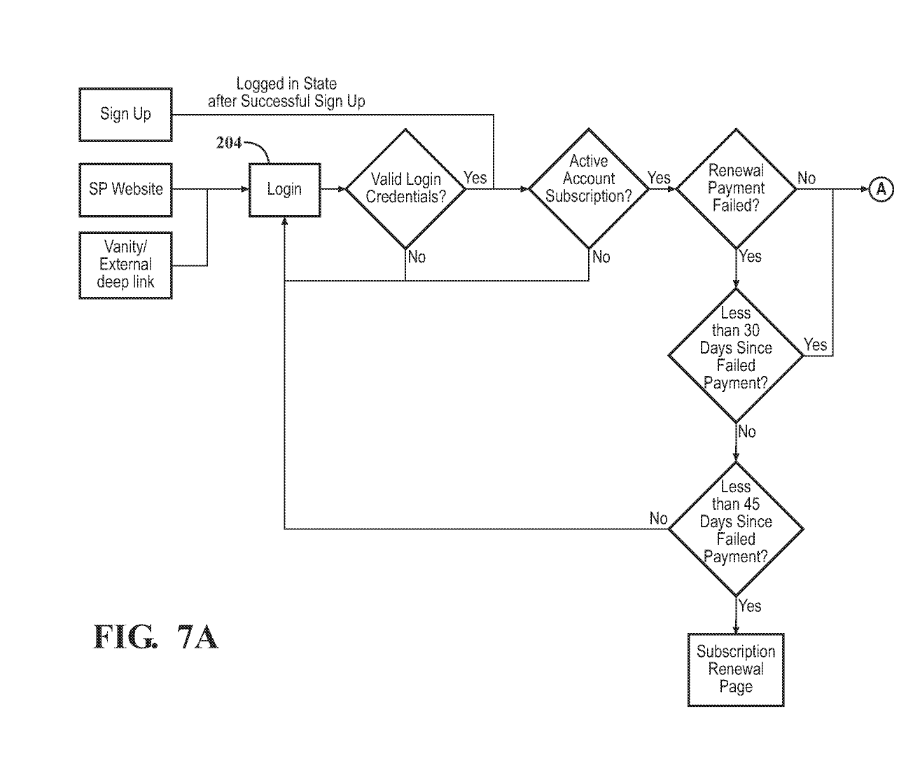

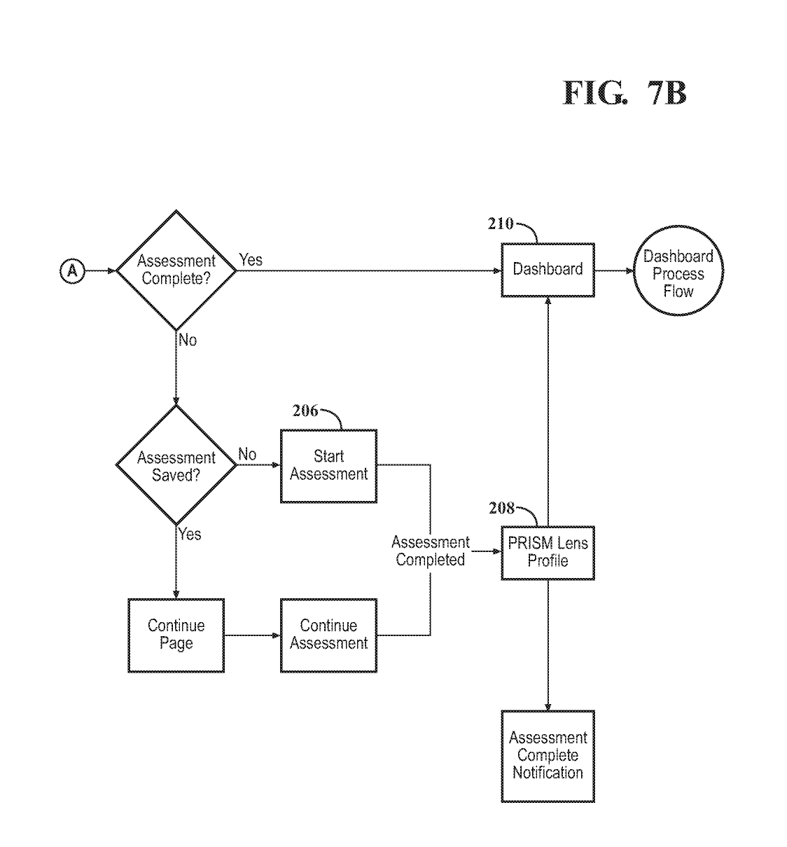

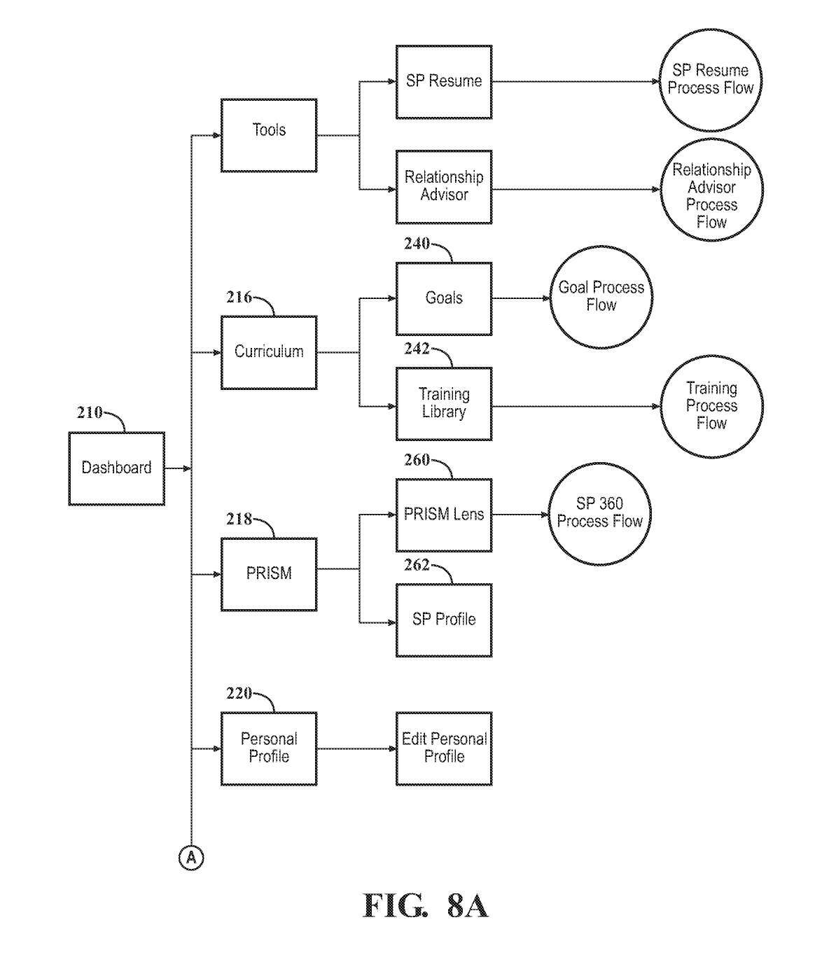

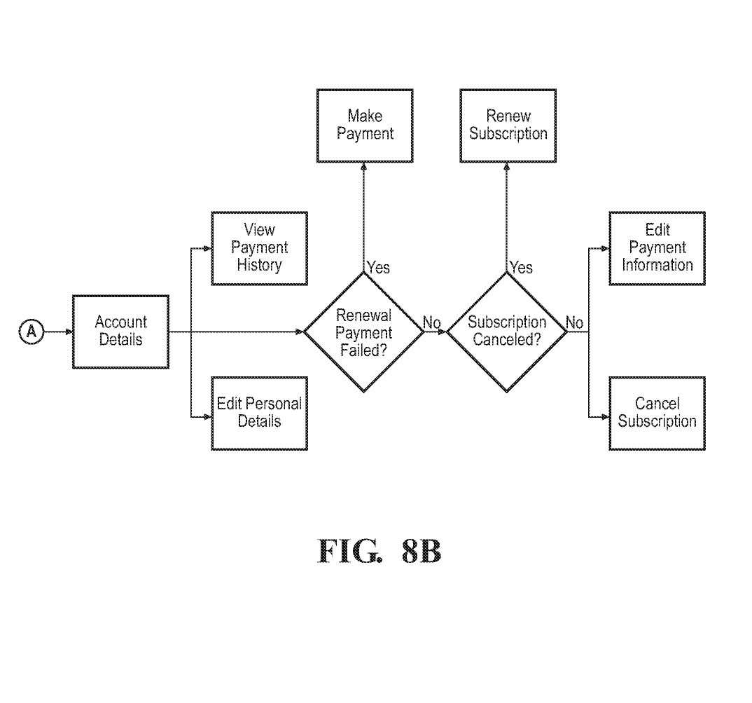

An individual may access the apparatus and method as described hereafter and shown in FIGS. 6-11I. Such individuals may be employees of a particular business who is registered with the apparatus and method, as described above, or totally unrelated to a particular business. An individual, as shown in FIG. 6, can individually register in step 200 or register through a business in step 202. After logging in in step 204 in FIG. 7A, an individual can start and/or continue the assessment 206 to create a 360 degree profile 208 which is input to a dashboard 210 for each individual in FIG. 7B. The dashboard 210 as shown in FIGS. 8A and 8B, allows access to a tools module 212, and a prism module 218.

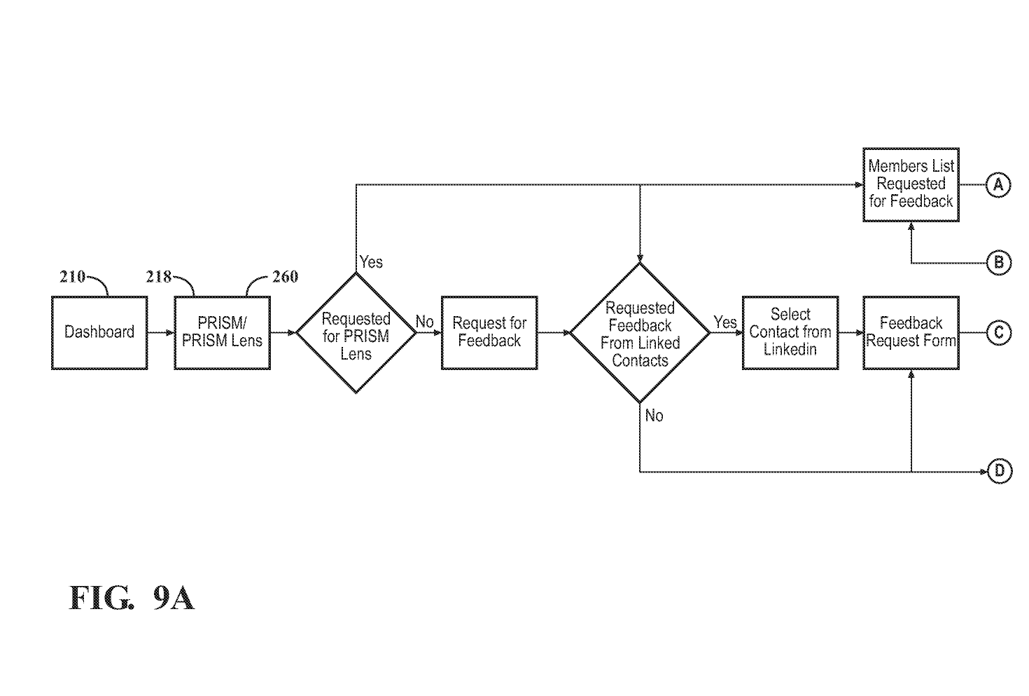

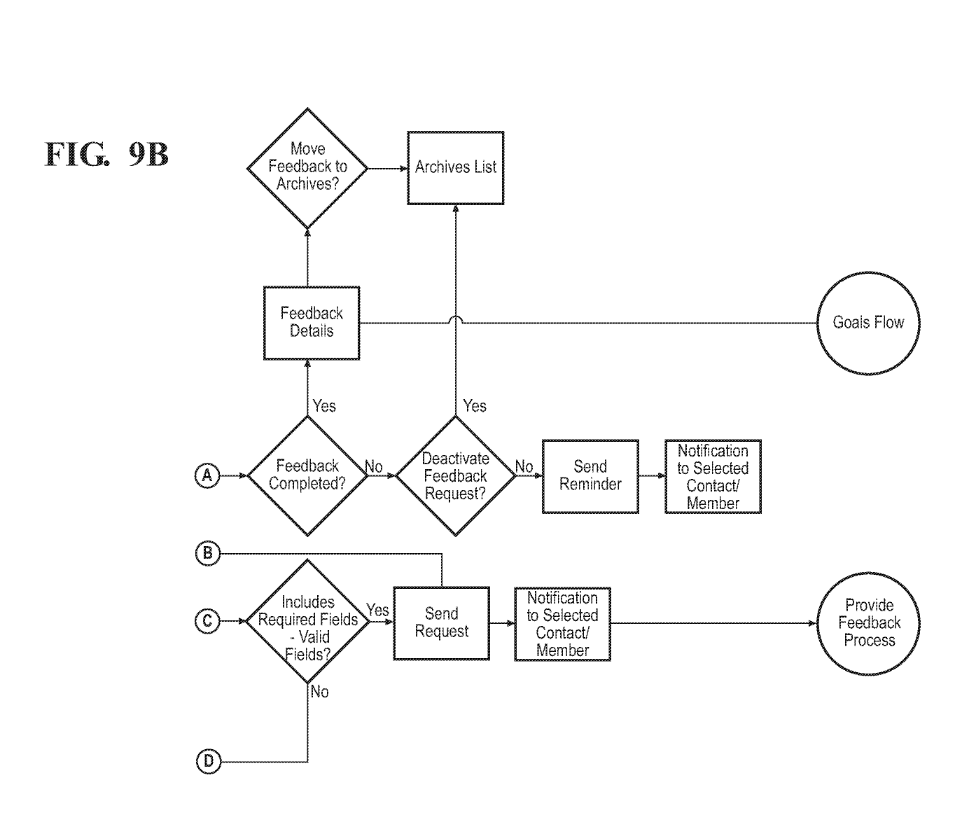

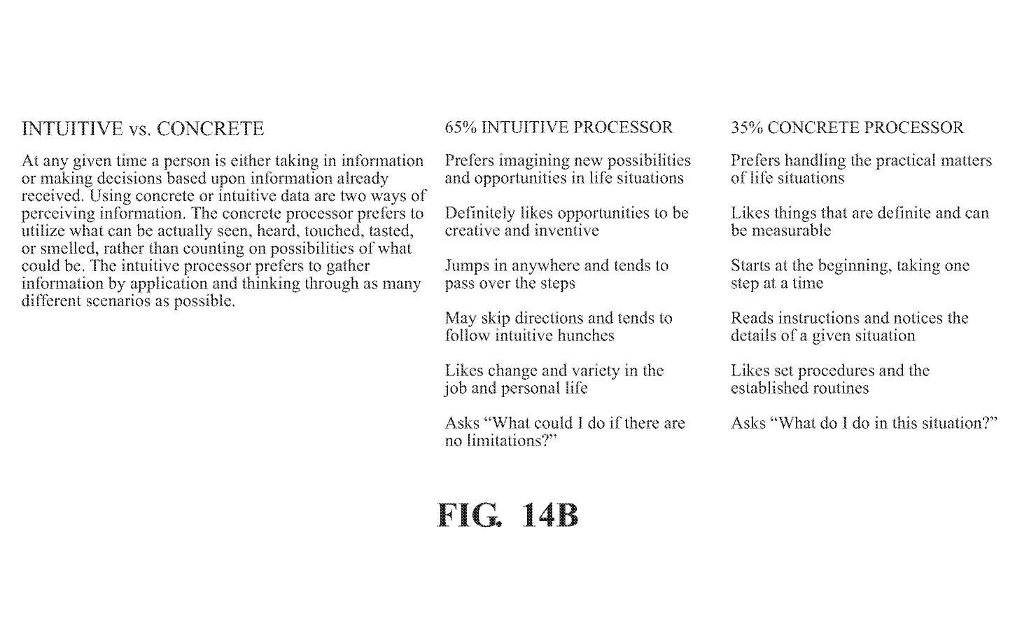

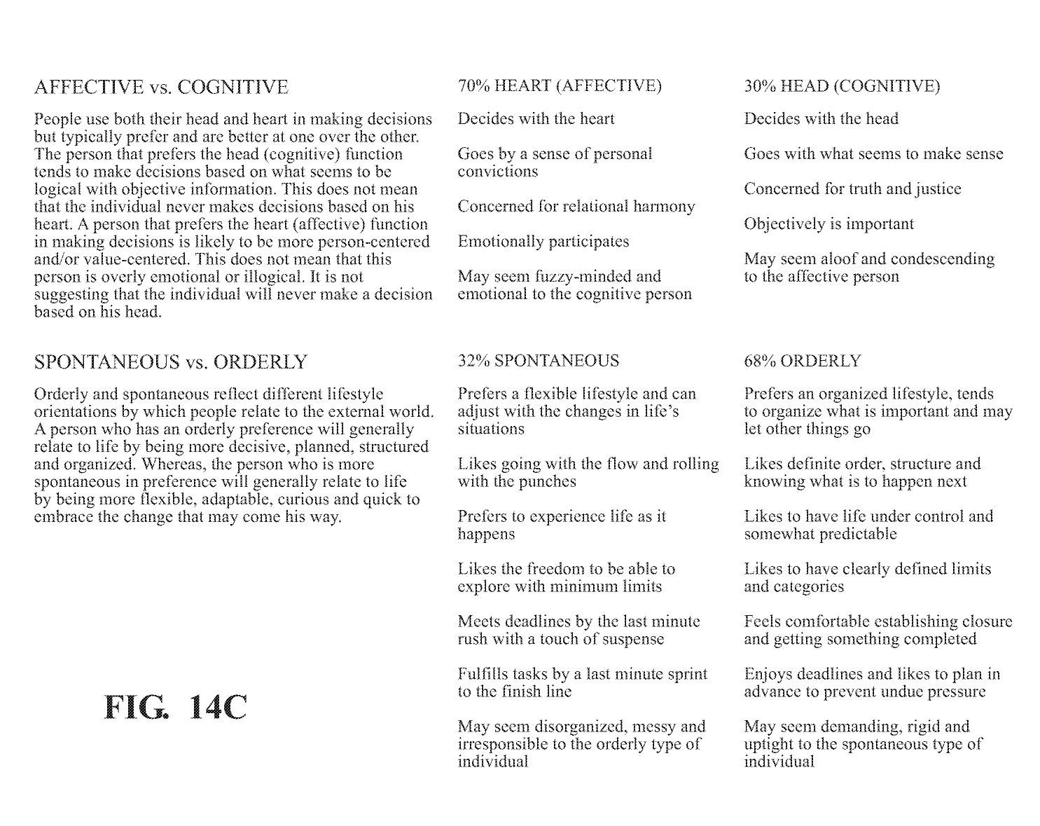

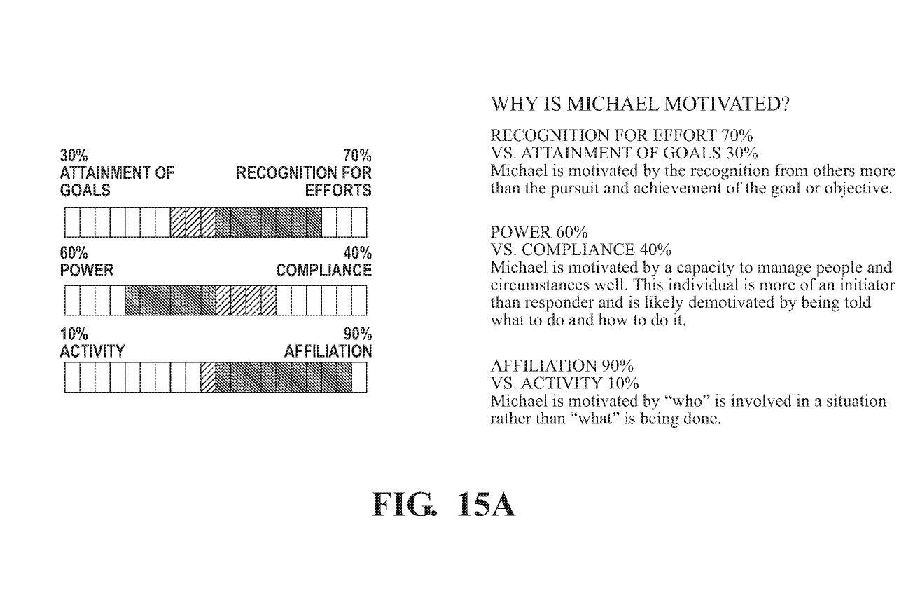

As shown in FIGS. 9A and 9B, an individual, through the PRISM LENS™ module 218, can access the PRISM LENS™ assessment 260 or review the individual's profile 262. As shown in detail in FIGS. 5, 8A, 8B, 9A, and 9B, when the individual selects the PRISM LENS™ assessment 260, the individual can select contacts or members for assessment by the sequence shown in FIGS. 14A-14C and receive feedback and actionable recommendations to improvements on the employees.

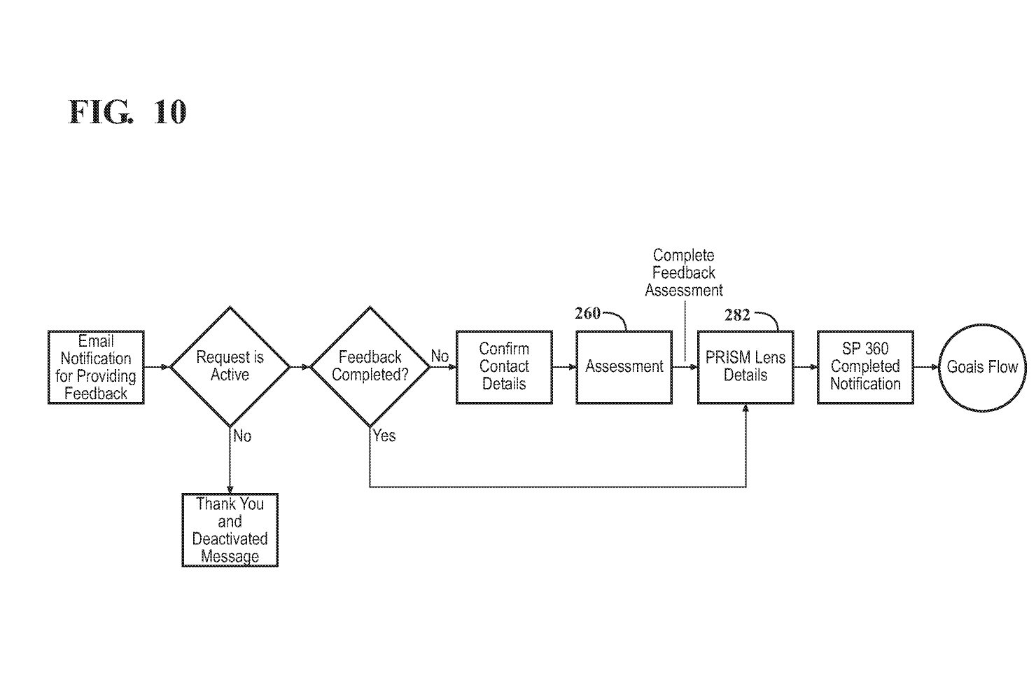

Finally, as shown in FIG. 10, an individual can access and complete the assessment 260 and receive an assessment report 282.

The PRISM LENS™ module 92 is further shown in detail in FIGS. 4A and 4B, when the PRISM™ module 90 and the PRISM LENS™ assessment tool module 92 are accessed through the dashboard 62. The PRISM LENS™ assessment module 92 allows a business administrator to select one or more individuals or employees of the business to provide an assessment of one employee. After receiving a request for the PRISM LENS™ assessment 92 in step 94, the business administrator can select one or more members from a list 96 and then send a request form 98 to the selected members.

The PRISM™ 90 assessment takes large amounts of data and converts the data to make it easy for businesses and employees to see, understand and put into action. The PRISM™ 90 assessment functions to identify multiple attributes including personality profile (primary and under pressure), processing blueprint, motivation, conflict management, fundamental needs, decision making and learning style.

The assessment apparatus and method creates a number of distinct primary employee personality profiles and employee personality profiles under pressure to assist a business administrator in determining whether or not to hire an employee, as well as determine how the employee is interacting with other business or business team members and the fit between employees on a team. Such personality profiles can include, for example:
Scientist Researcher
Navigator
Visionary
Architect
Catalyst
Tough & Tender
Connector
Instructor
Ally
Pragmatist
Strategist
Influencer
Peacemaker
Pioneer
Ambassador

The apparatus and method establishes characteristics for each of the personality profiles describing how an employee having a particular personality thinks, makes decisions, handles tasks and other personal relationships, work environment preferences. Each personality also has a list of work style characteristics, as well as how this particular individual with a specific personality may fit into a particular business team, how the individual is likely to communicate with team members, how the individual is influenced by negative perceptions of or by other team members. Such characteristics also enable a supervisor to best supervise and encourage an individual with a particular personality profiles.

These personality profiles enable a business administrator, when forming a team of employees or hiring a new employee as an addition to an existing team, to best choose the team members or the new employee to fit into the team, and to meet the goals of the team.

These personality types and personality under pressure types are established by the assessment program which asks an individual a series of questions describing workplace scenarios, preferences, motivation, work styles, etc. Based on the answers, the assessment program of the apparatus and method establishes a particular personality type for an individual. The established characteristics associated with that individual's personality can then be established for the business administrator.

This assessment information is valuable to the business administrator when forming a team, determining the efficiency of an established team, or when conferring to hire a new employee and placing that employee in a particular team. This enables the business administrator to achieve the business goals in an efficient manner, as well as advancing the growth of each employee.

A business employee, as well as non-business individuals, who take the PRISM™ 90 assessment, are provided with a custom portrait of their personality, how they operate in a business environment when making decisions, interacting with others, achieving goals, for advancing the individual to meet business-related and/or life goals.

Appendix A depicts a number of different personality profiles used by the present assessment apparatus and method. These personality profiles are examples only as the number of personality profiles used by the apparatus and method can include less than or more than the different personality profiles described in Appendix A.

The personality profiles shown in Appendix A as well as the actual assessment as described hereafter are provided by way of an example as any available assessment program may be employed in the present apparatus and method. The personality characteristics of any individual from any available assessment can be correlated to the sixteen personality profiles and the seven assessments described hereafter.

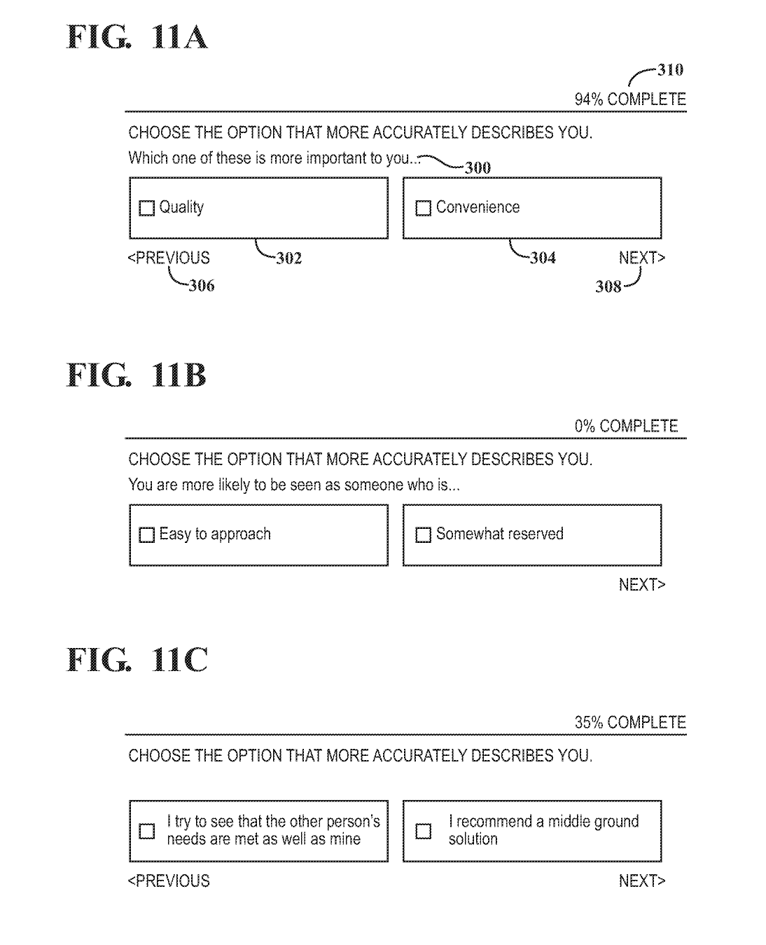

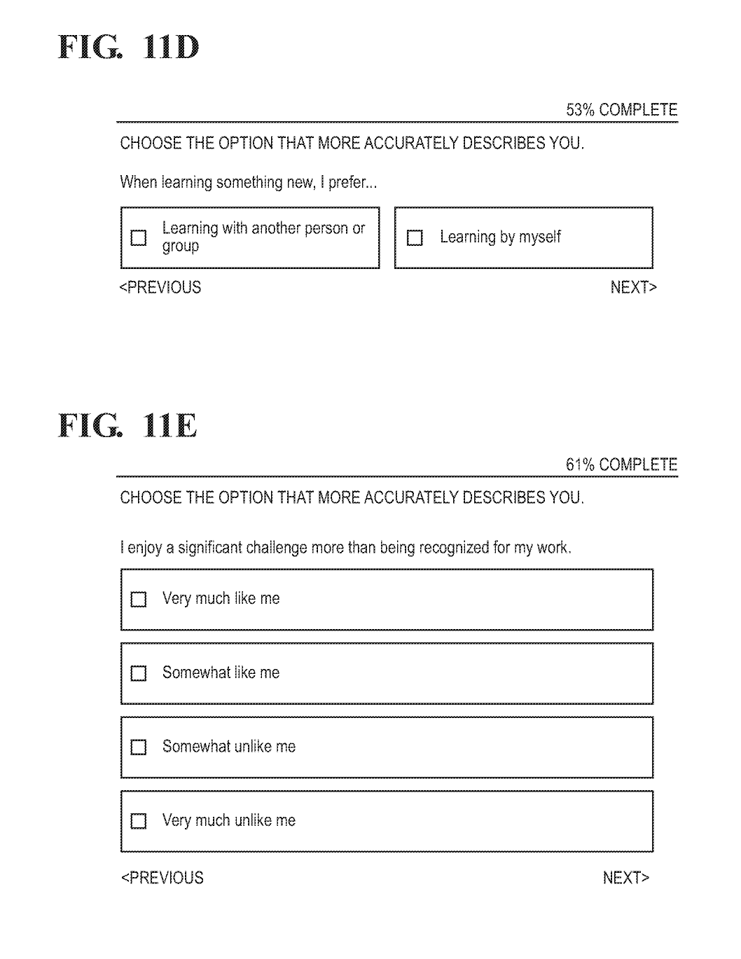

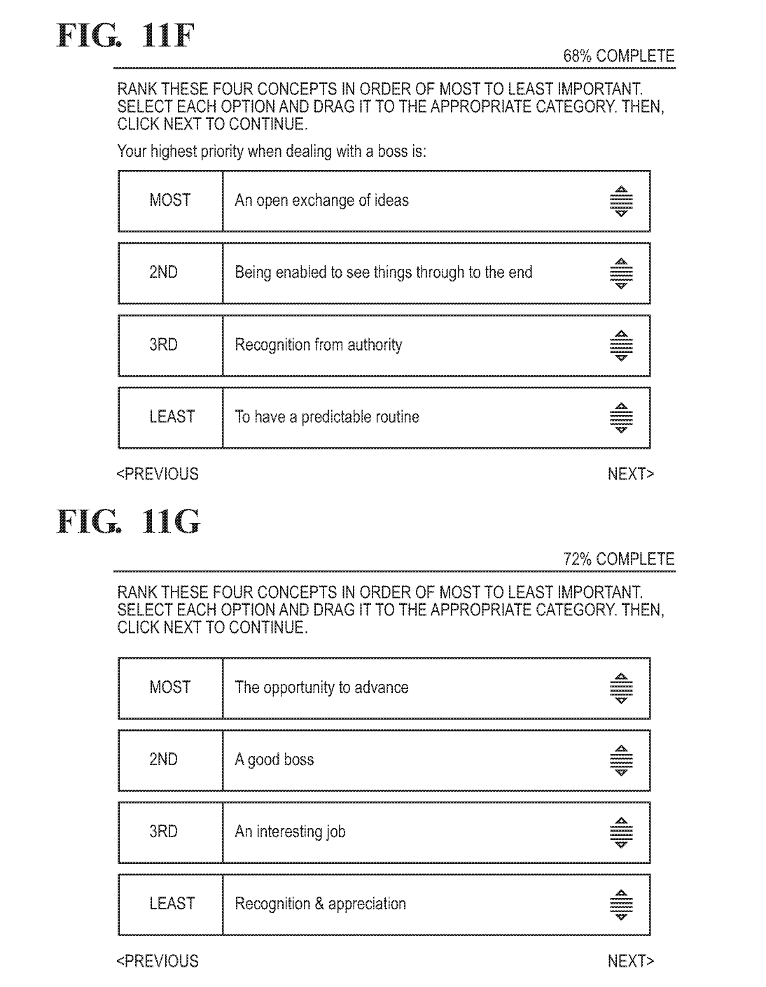

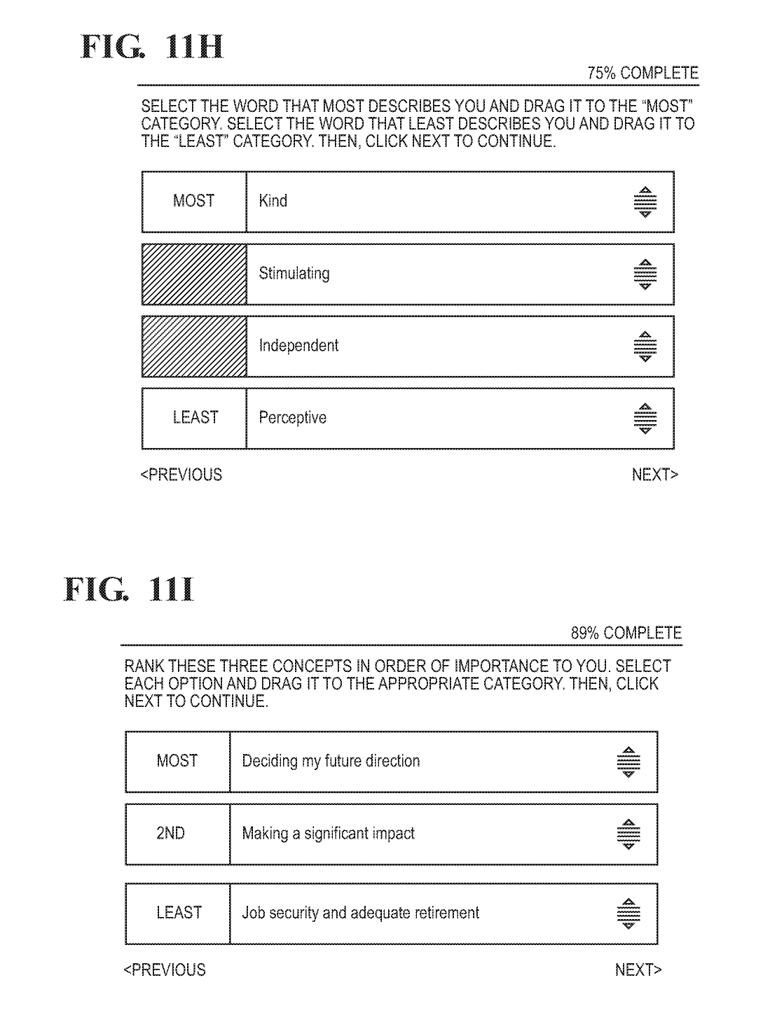

FIGS. 11A-11I depict different forms of assessment questions presented to the individual as part of the PRISM™ 90 assessment. The questions are displayed on a monitor and generally ask an individual to choose the characterization that most generally describes that individual's view of the assessment question. The page displayed on the monitor also enable the individual to easily return to a previous question or to advance to the next question. The display also depicts the percent completion 310 of the entire assessment 90.

The data driven assessment apparatus and method presents the personality and the individual characteristics in easy to read scales, charts and graphs to enable a business administrator or the individual to easily ascertain the individual's personality, decision making tendencies motivation, etc.

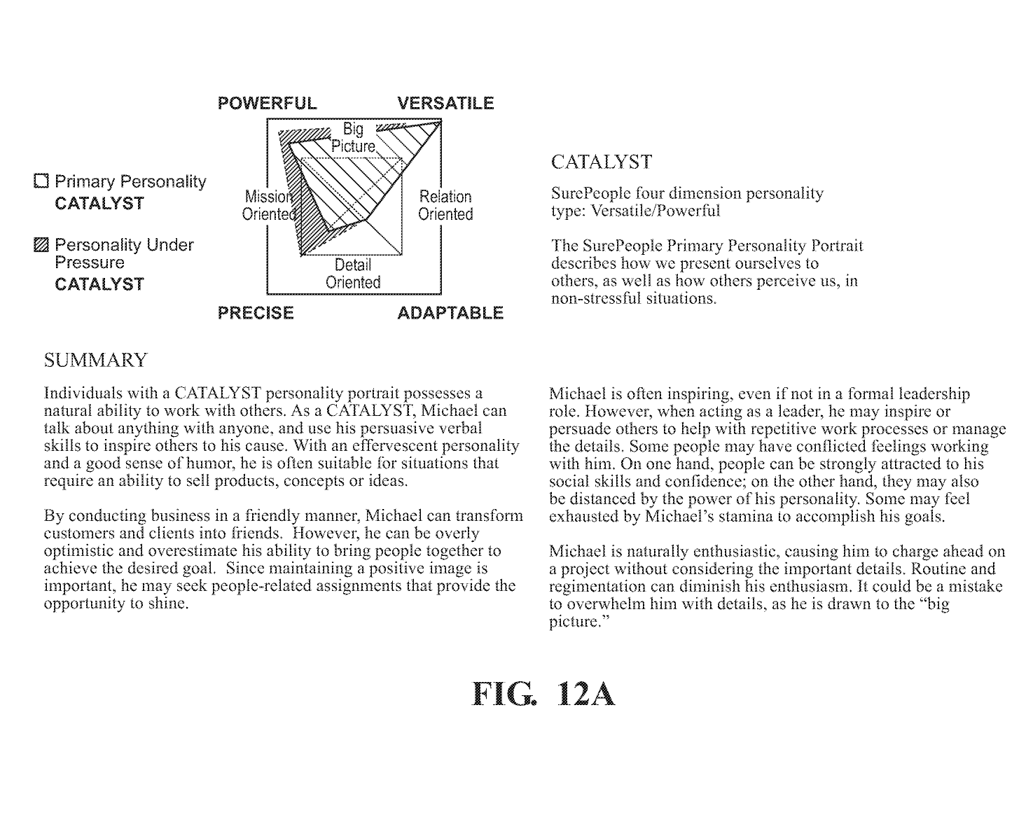

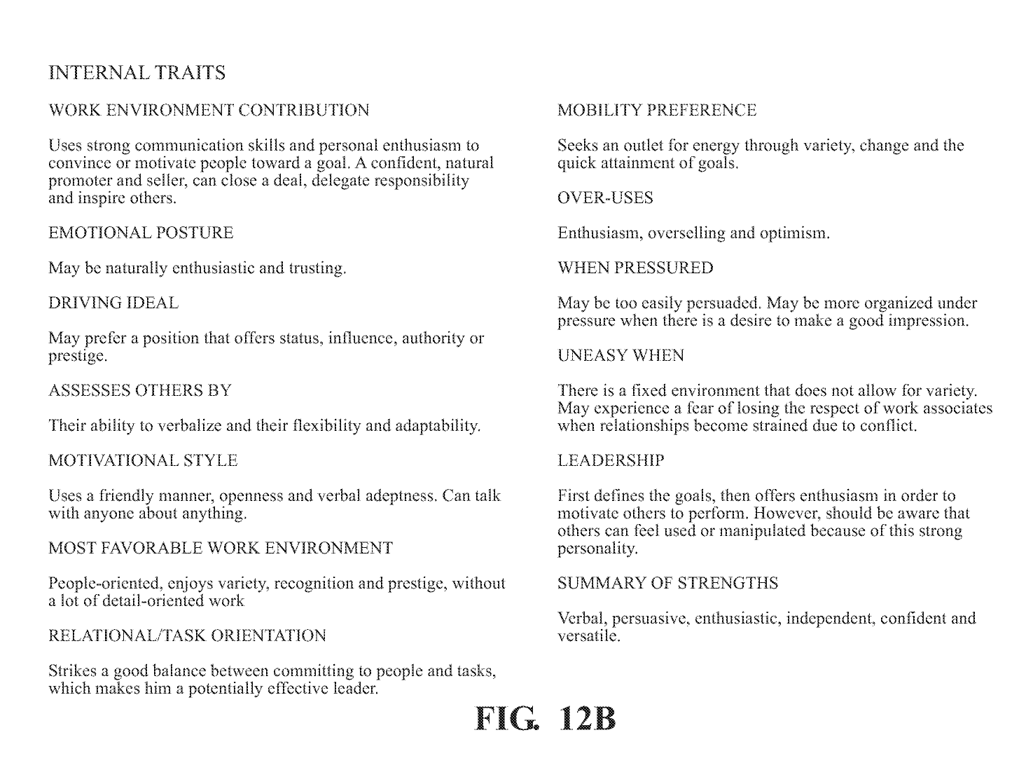

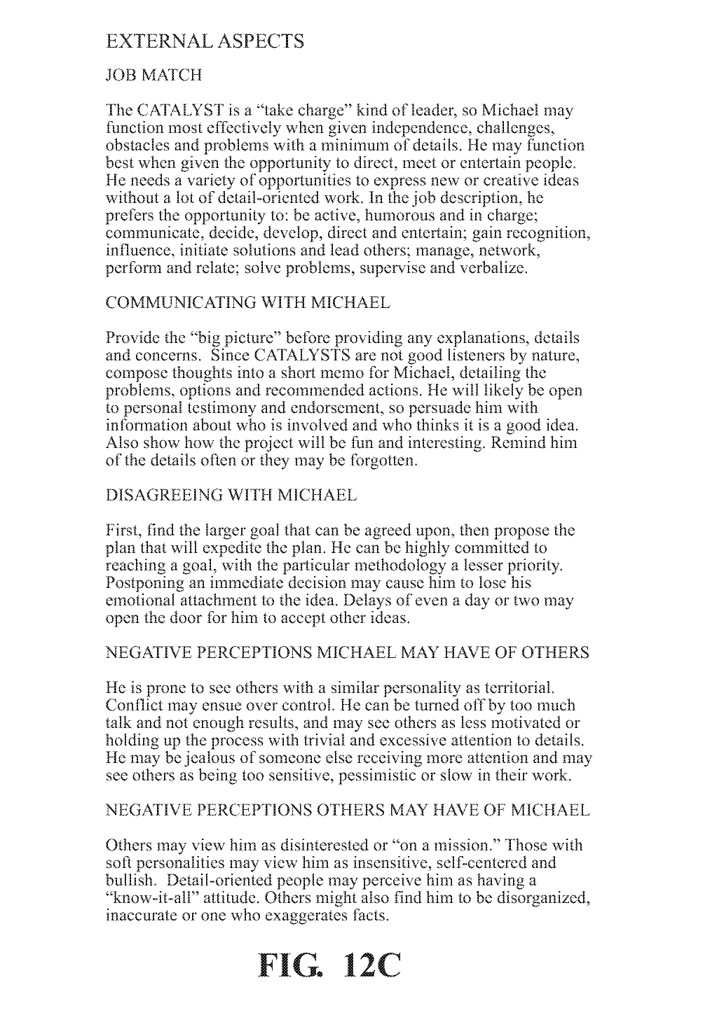

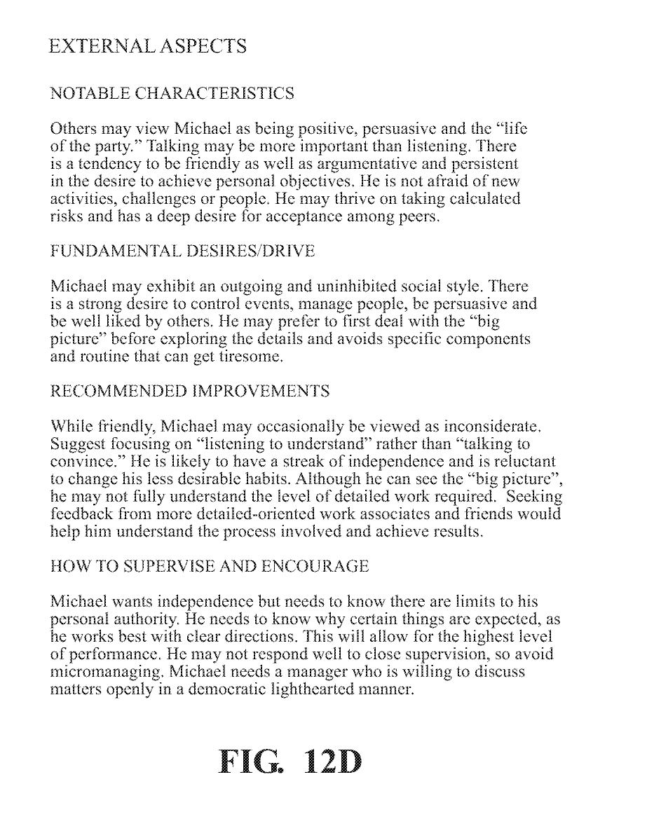

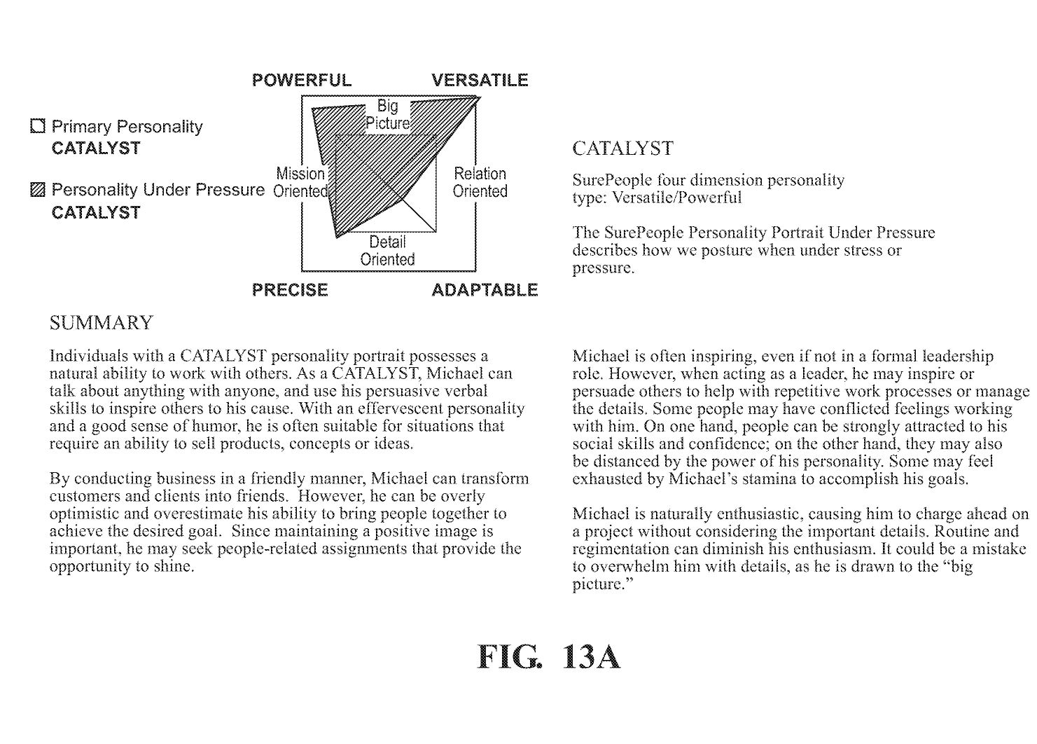

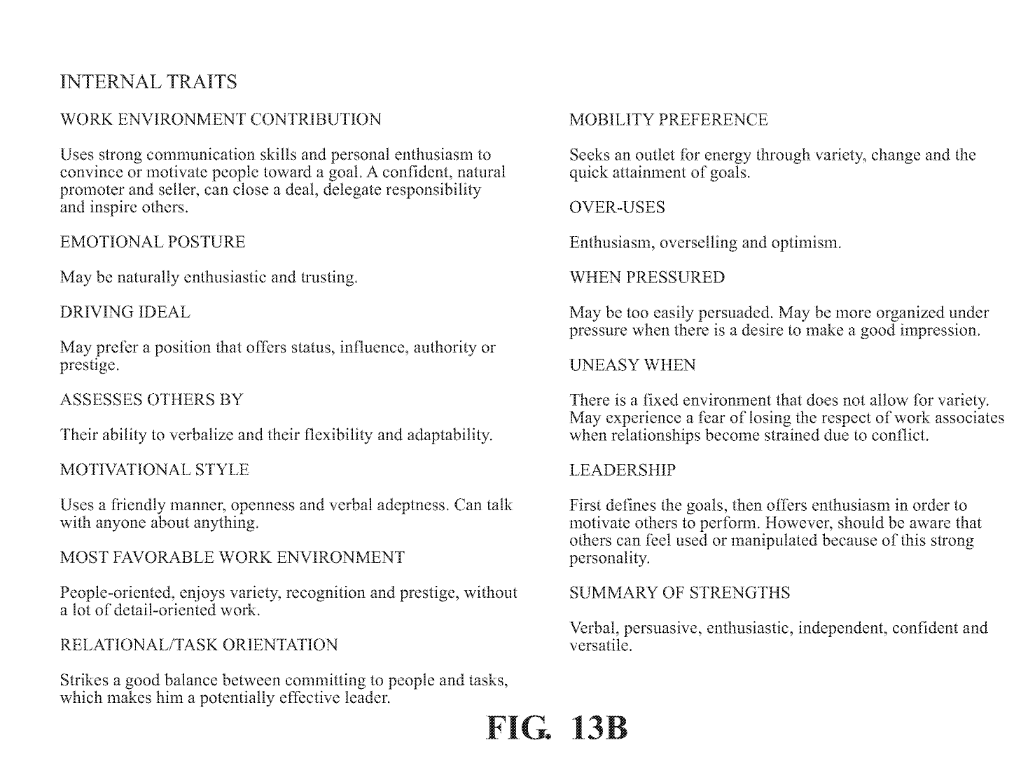

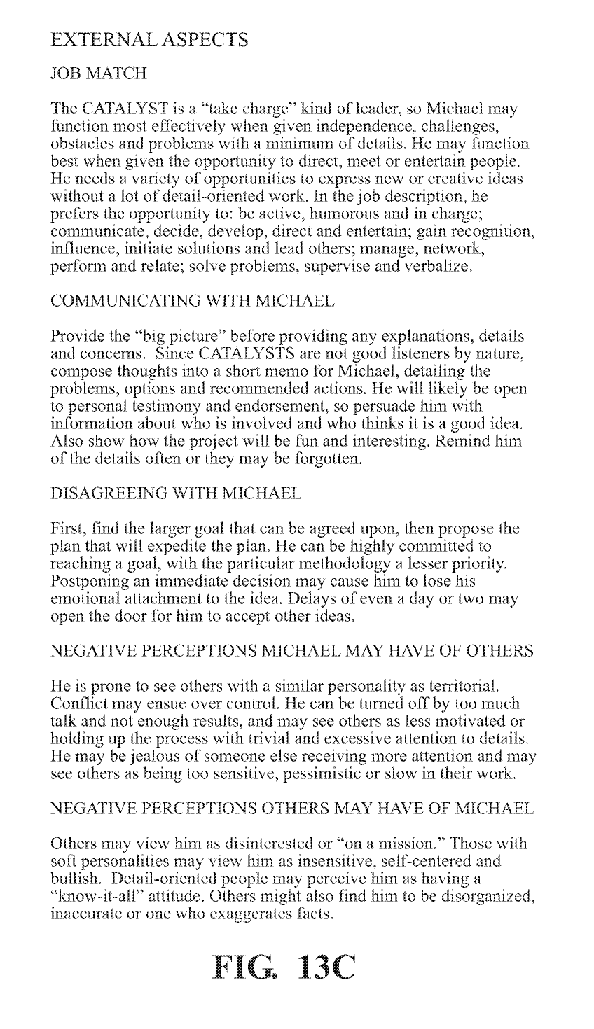

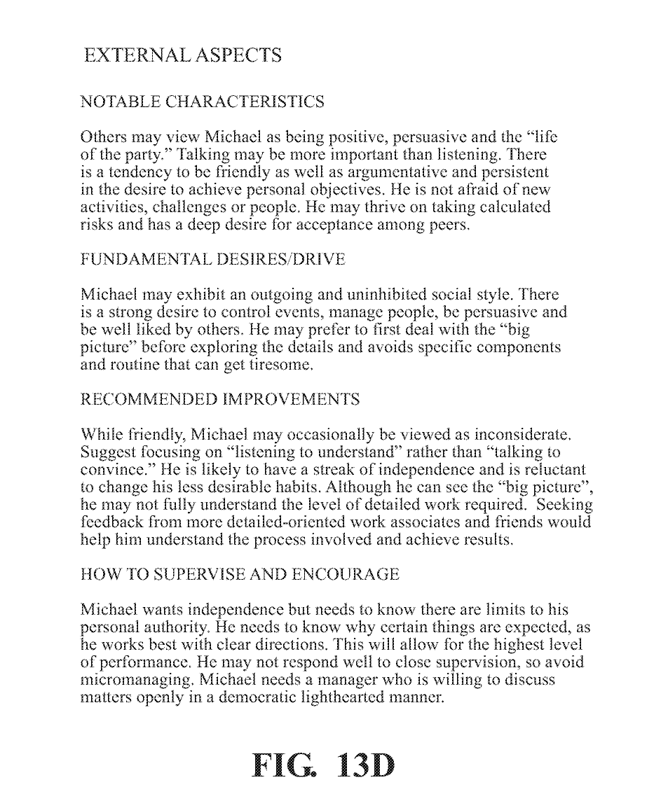

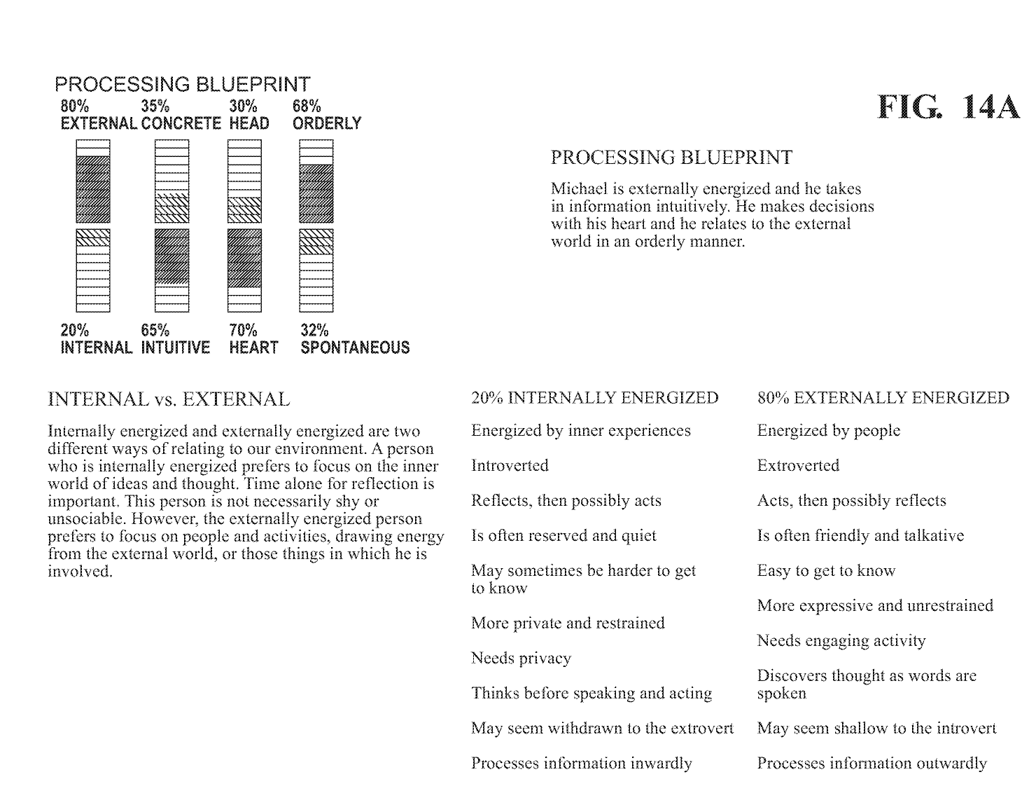

The PRISM™ 90 assessment reveals both primary personality in FIGS. 12A-12D and personality under pressure in FIGS. 13A-13D within a four dimensional scale that measures power, versatility, precision and adaptability. The PRISM™ 90 assessment delivers a comprehensive summary filled with insights and a unique classification for people to see, read, and understand their personality.

Not everyone absorbs information in the same way. After processing information, some people will make decisions more with their head, while others tend to take action with their heart. The processing blueprint feature of PRISM™ 90 assessment shown in FIGS. 14A-14C shows how employees approach people, activities, thoughts, and causes in their lives based on four distinct scales, including:

Internal vs External: How people are energized by outside factors or inner thoughts and concepts.

Intuitive vs Concrete: The way people take in and perceive information.

Head vs Heart: If people tend to make decisions guided more by their thoughts or feelings.

Spontaneous vs Orderly: How people prefer to approach and relate to live.

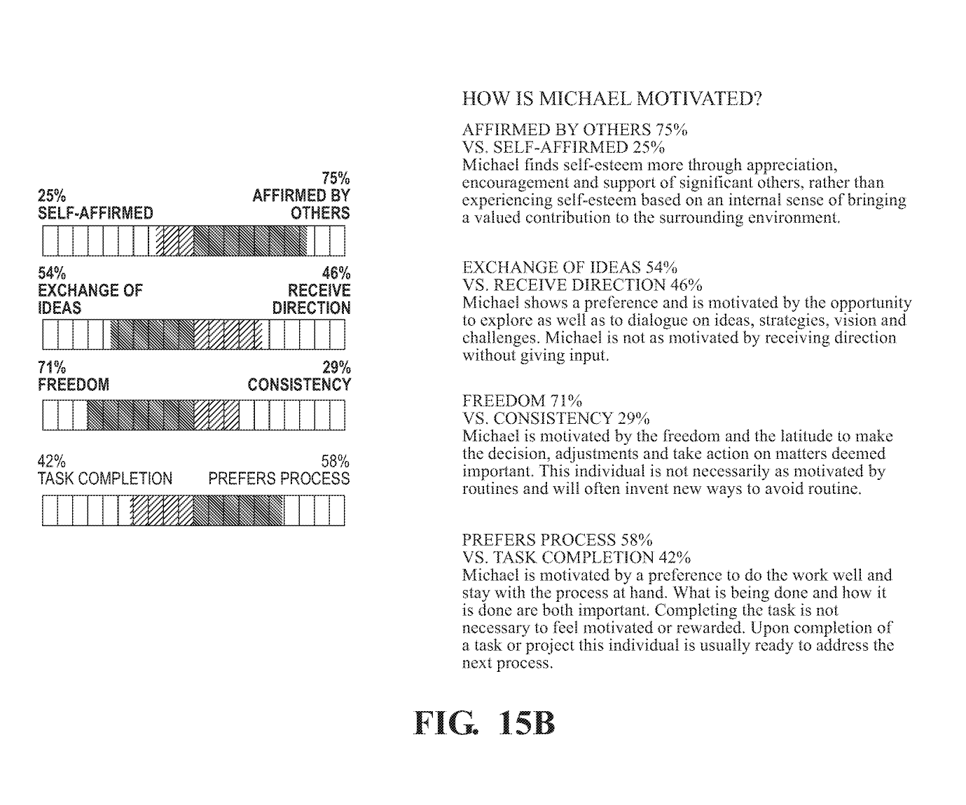

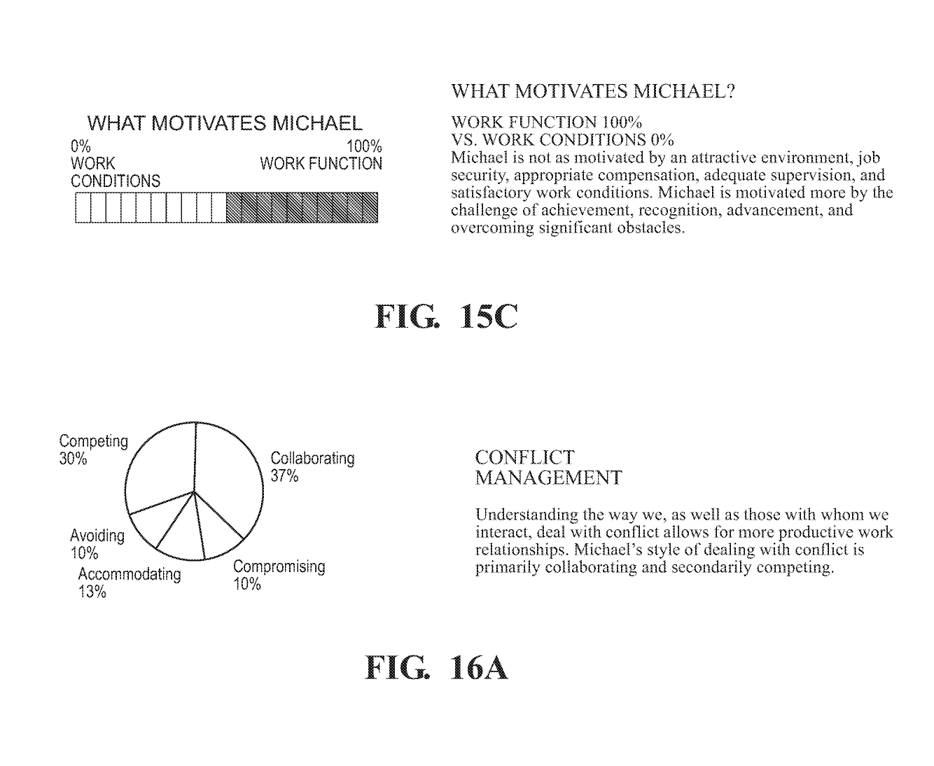

Motivation is also a determination of the PRISM™ 90 assessment, as shown in FIGS. 15A-15C. Some employees may want recognition while others need a little encouragement to keep moving forward. The motivation output of the PRISM™ 90 assessment uncovers how people are motivated, why they are motivated, and what they are motivated by.

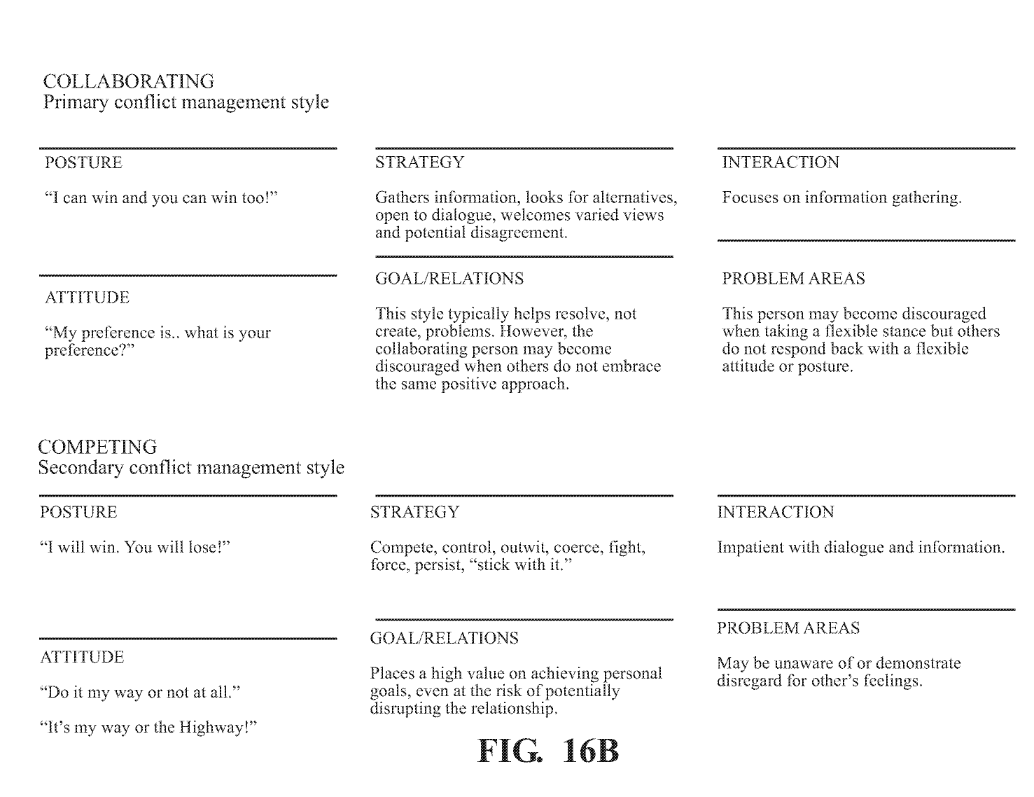

How employees deal with workplace conflicts is important since such conflicts arise all the time. The conflict management output of the PRISM™ 90 assessment, as shown in FIGS. 16A and 16B reveals how a business's employee's or prospective employees work through issues with others, by competing, calibrating, avoiding, accommodating or compromising. Such insights allow business administrators greater understanding on how the business's employees interact with one another and deal with conflict, thereby allowing the business administrator to foster more productive working relationship.

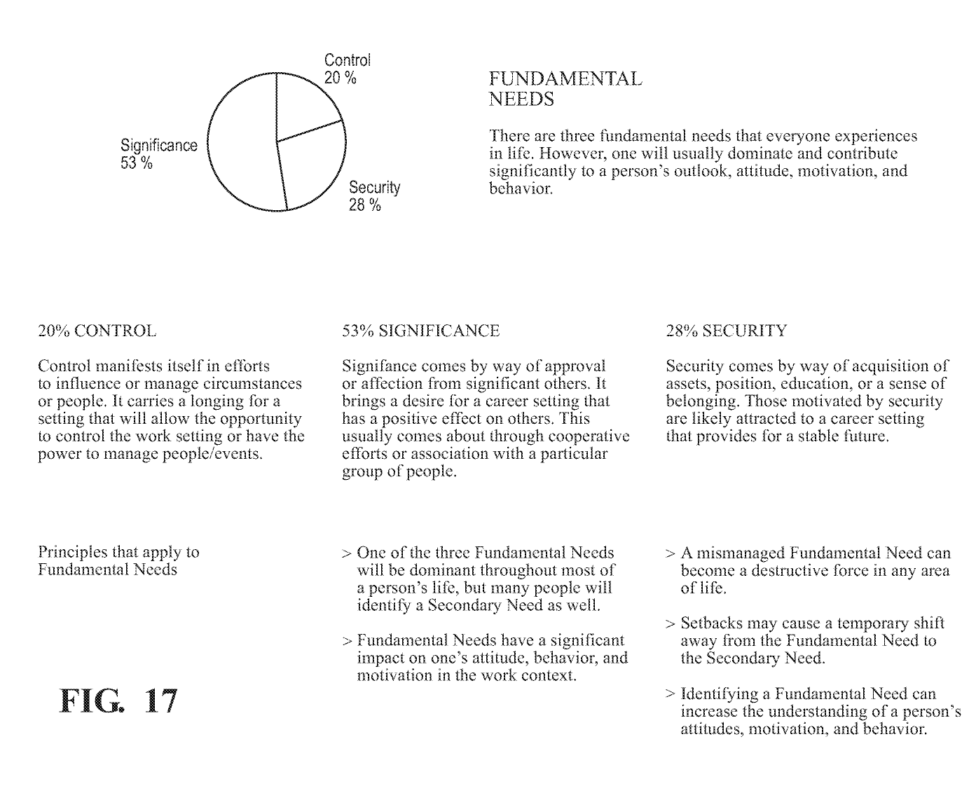

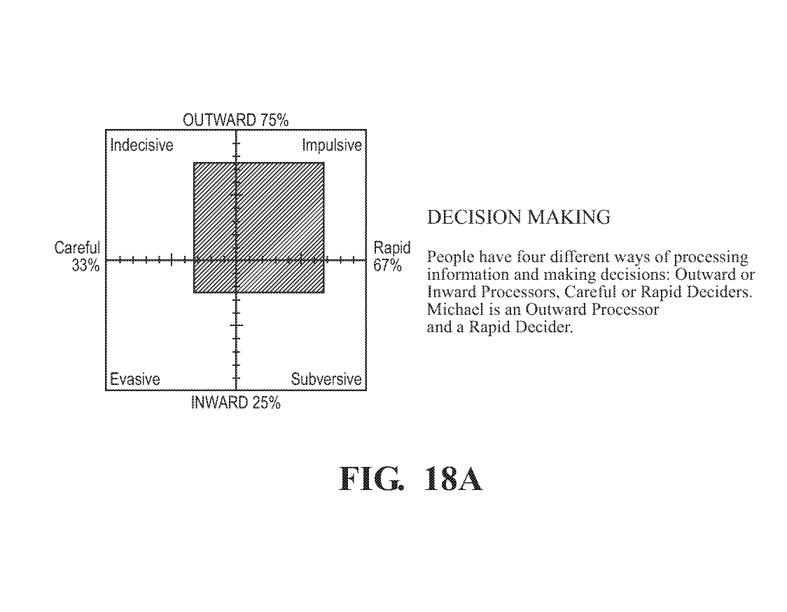

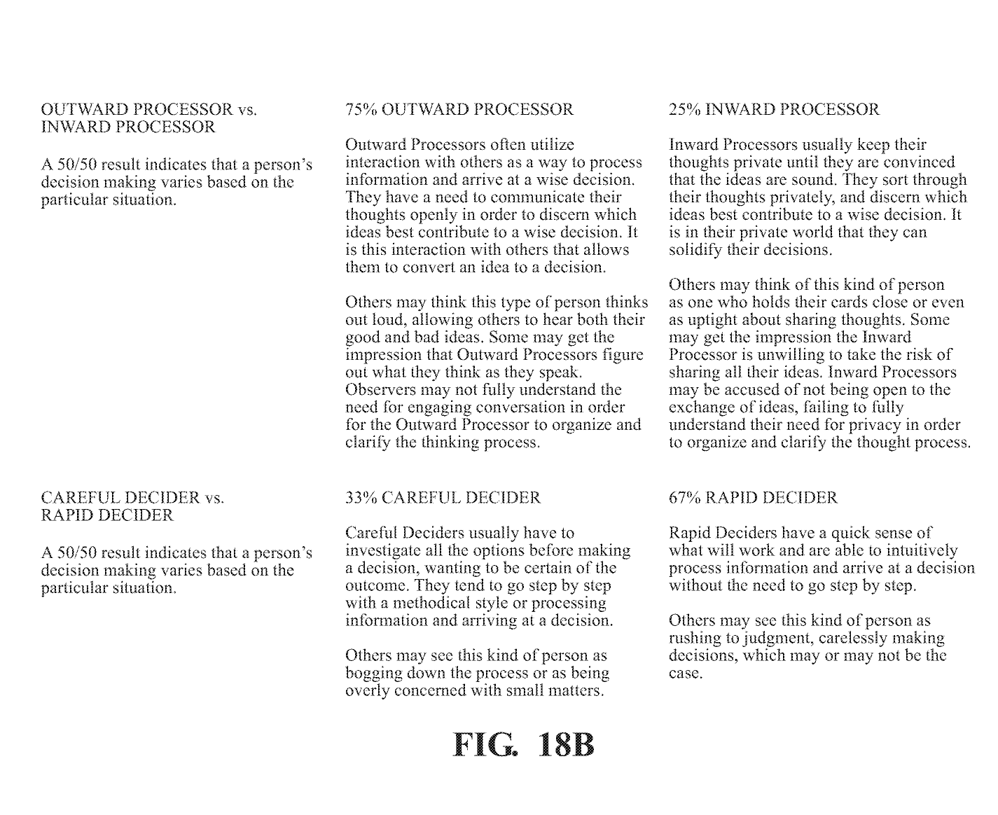

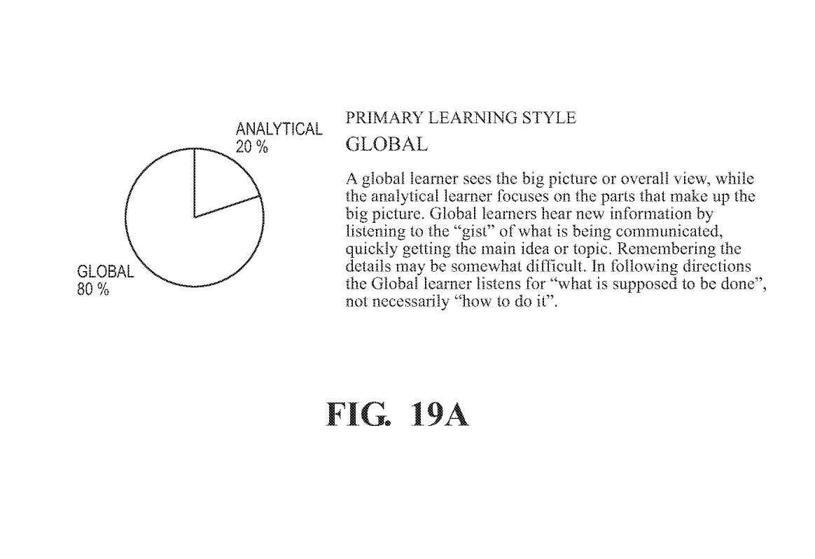

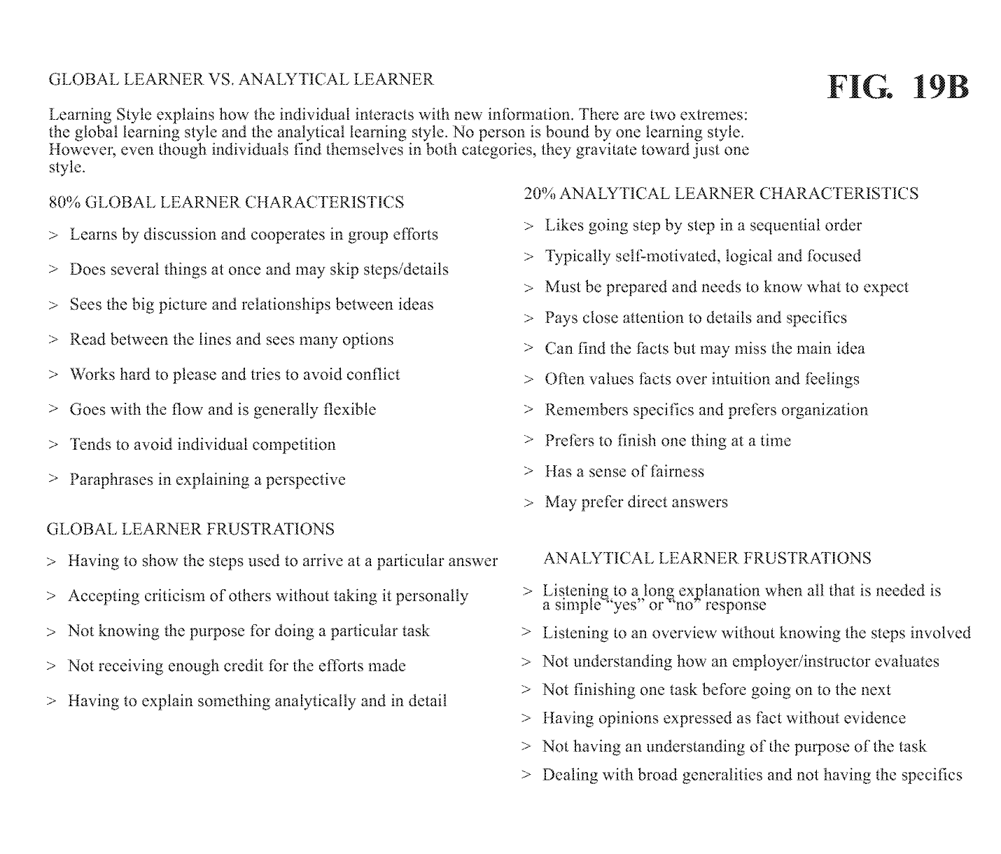

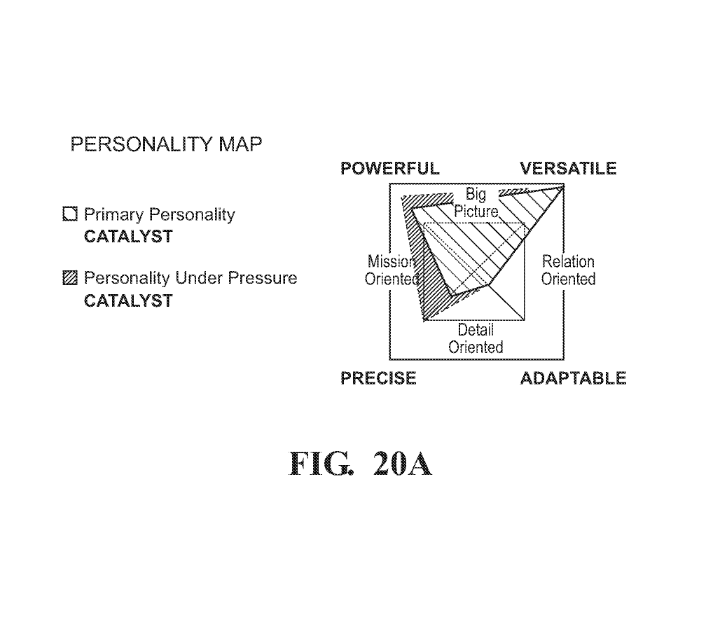

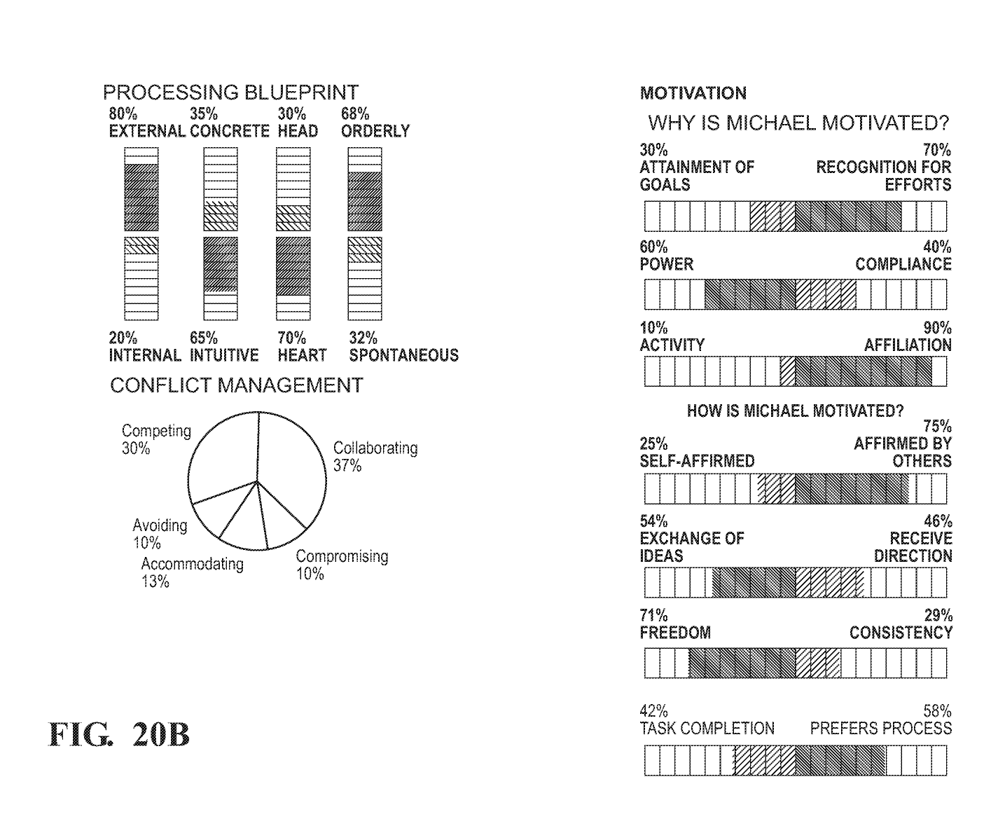

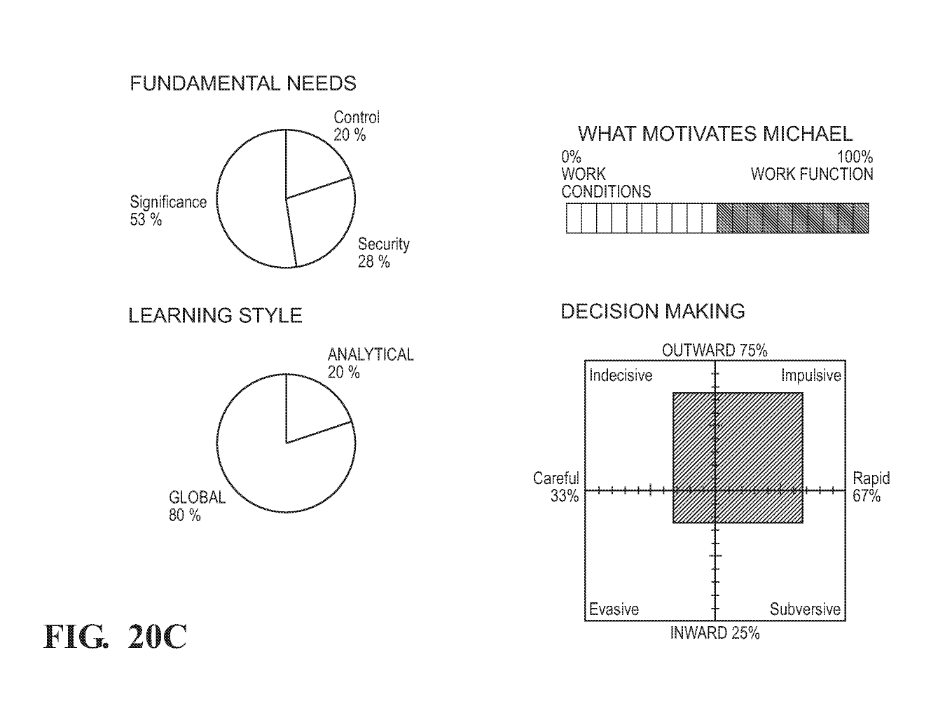

All employees have fundamental needs that drive the employees and contribute to their outlook, attitude, motivation, and behavior. The fundamental needs output of the PRISM™ 90 assessment, as shown in FIG. 17 measures a person's desire to maintain control, have security or achieve significance. These insights provide a business administrator with a deeper understanding about their employee's needs for helping team members to appreciate and communicate with each other.

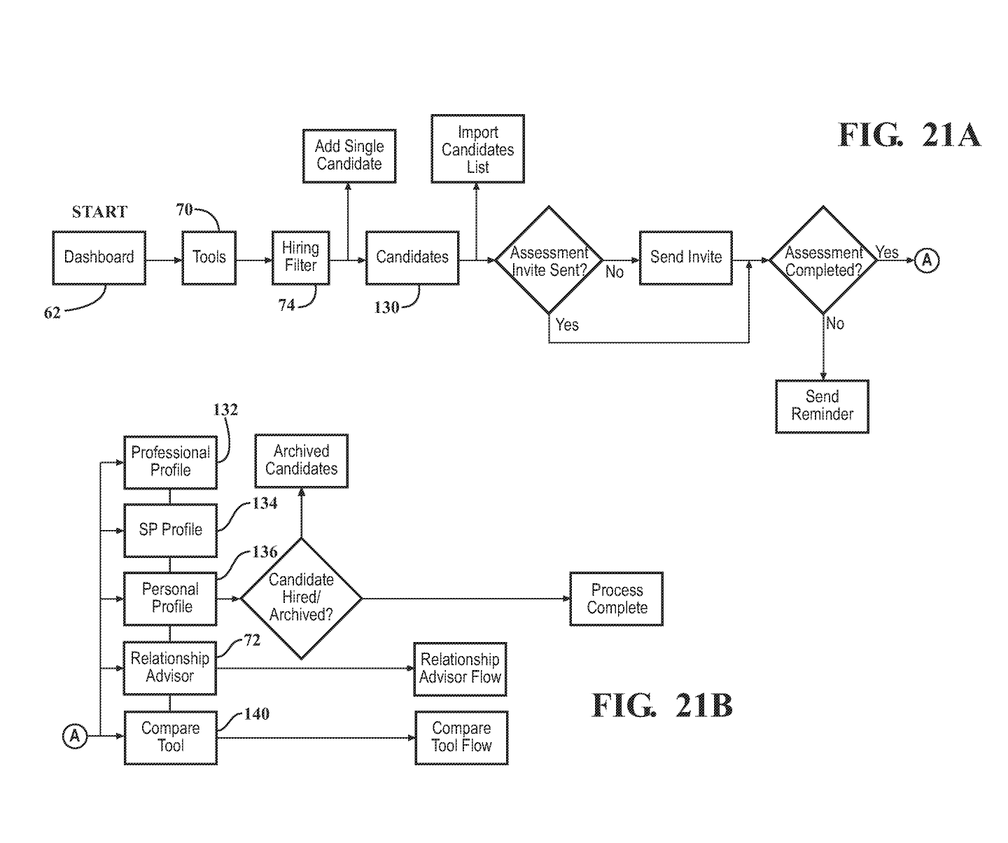

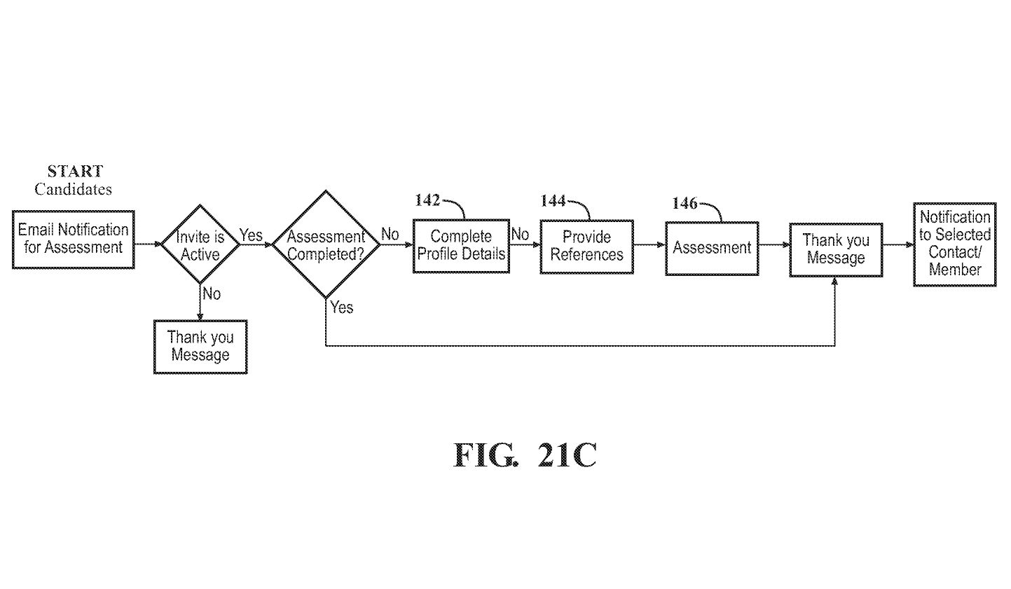

As shown in FIG. 3A, the business administrator can access, through the dashboard 62 and the tools module 70, the hiring filter module 74. A list of candidates is accessed in step 130 of FIG. 21A, and invitations to selected candidates are sent. In FIG. 21B, the hiring filter 74 enables access to a professional profile module 132, and an SP profile 134 for a particular candidate, a personal profile of the candidate 136, and a comparison tool module 140. The individual selected candidates complete profile details are accessed in step 142, provide references in step 144, and then enable an employee assessment survey 146 in FIG. 21C.

The PRISM™ 90 assessment provides a business administrator with predictive insights needed to understand who a candidate really is, choose the right hire for the company culture, improve organizational performance and decrease in employee turnover. The hiring filter module 74 provides information about a business's candidate's emotional, relational and team intelligence, matches up candidate profiles with employees, and identifies traits that make for successful hire and compares top candidates and reference checks.

The hiring filter module 74 matches up and compares candidate's profiles side by side to determine who would be the best cultural and behavioral fit for the business. Candidate profiles can also be matched with existing employees or a standard employee model assessment to bring in new dynamics to a business team or identify traits that lead to greater success and performance from the comparison tool module 140.

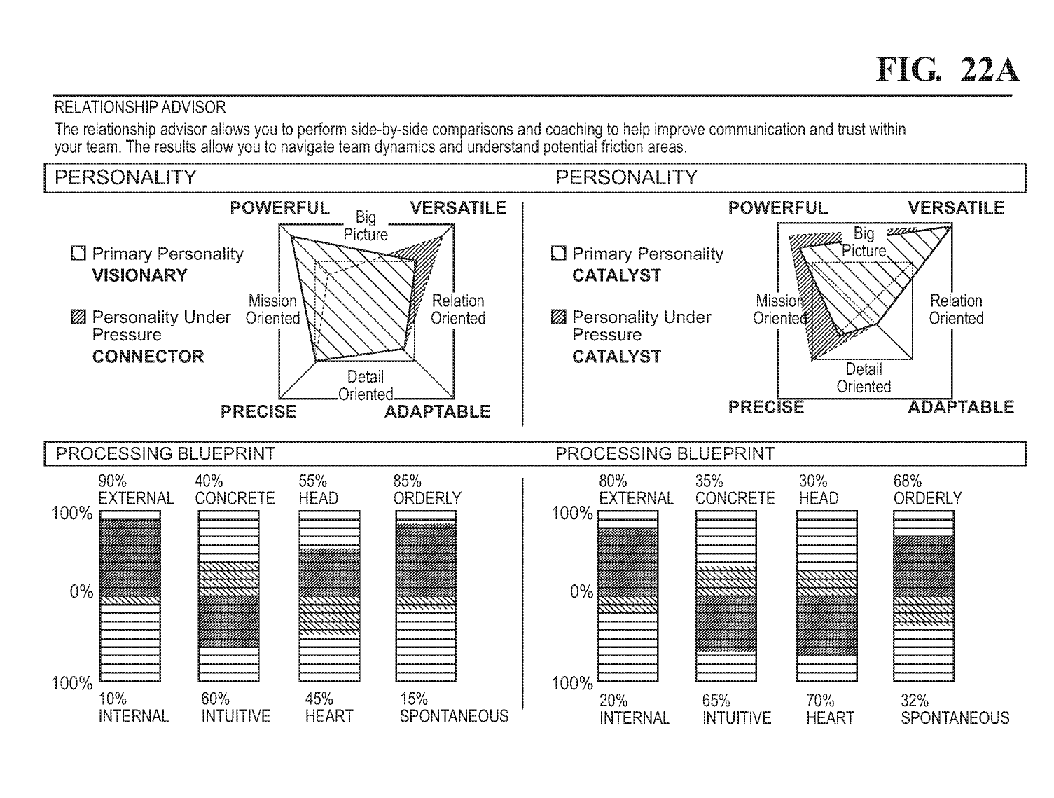

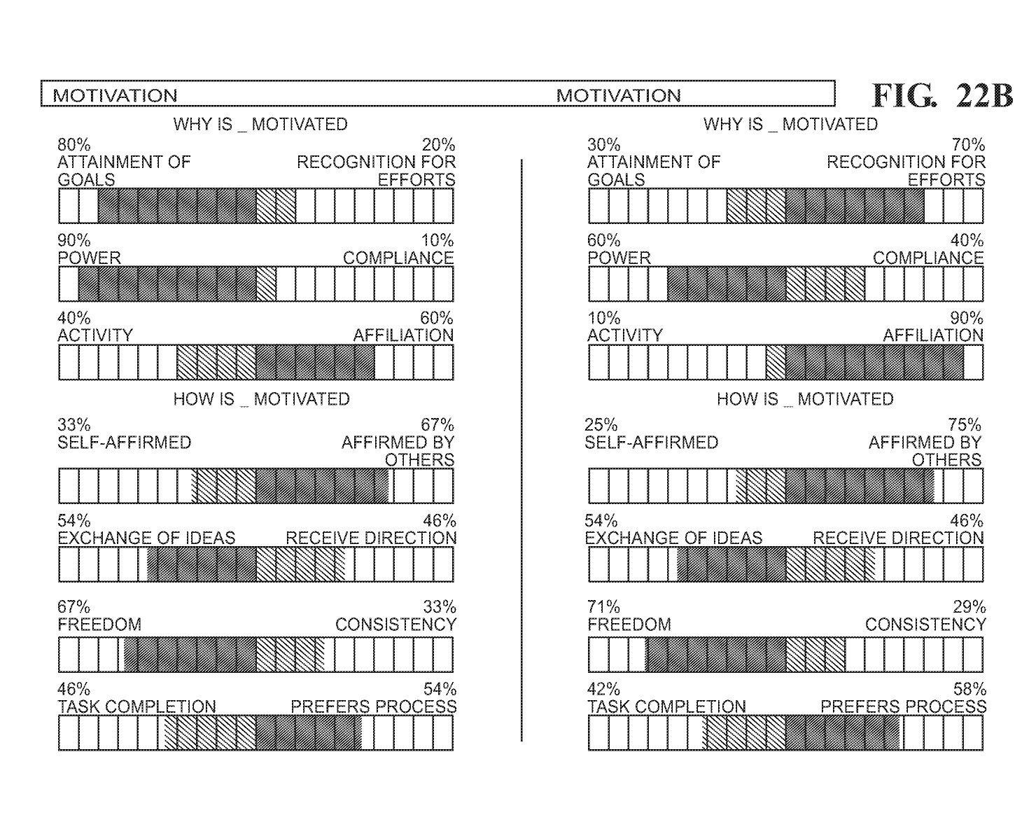

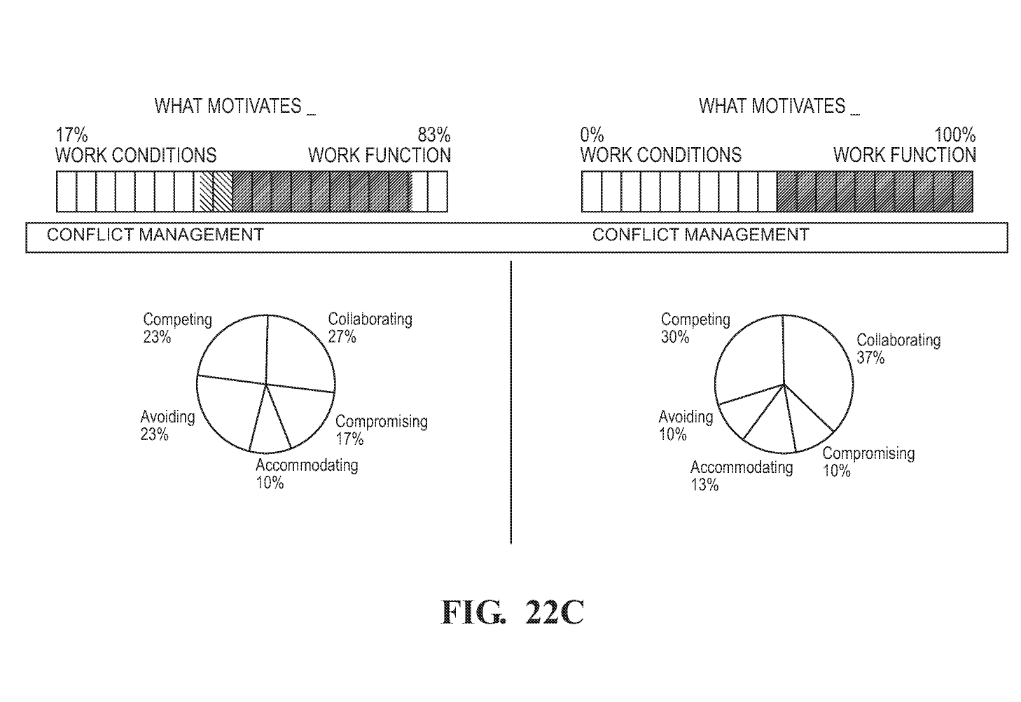

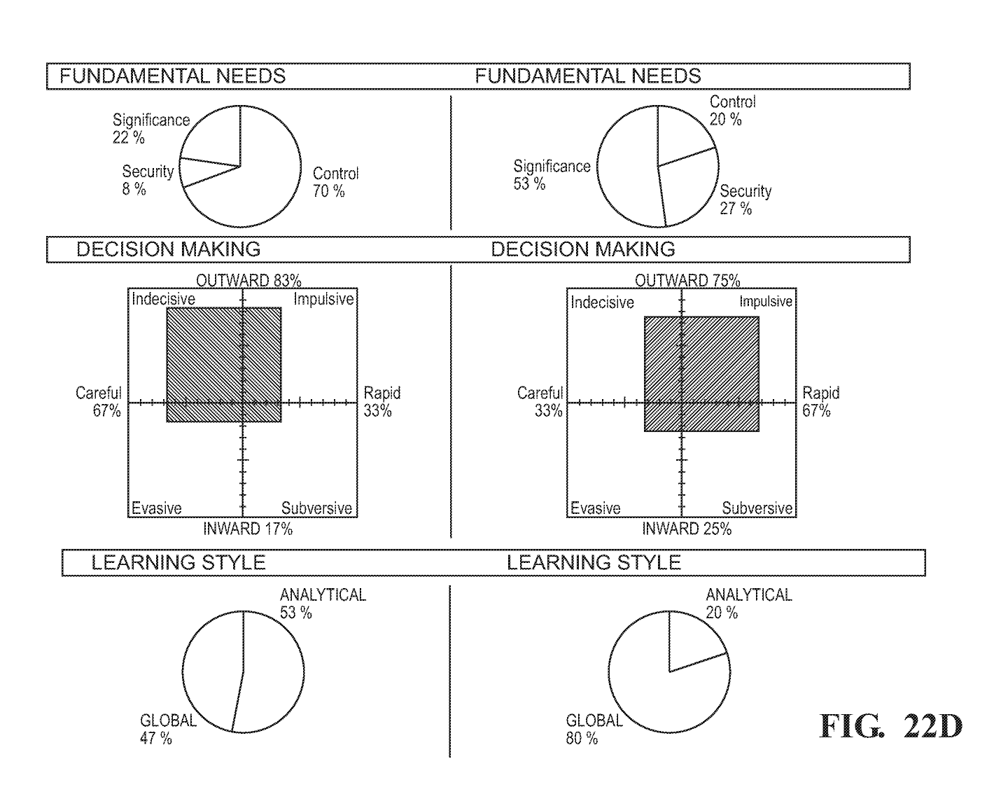

FIGS. 22A-22D show personality factors based on employee assessments of two candidates for primary personality of each candidate as determined by the assessments described above. Clicking on the primary personality switches the personality display to the personality under pressure of assessment each individual. The graphic displays provide an easy view of each candidate's personality and traits, thereby allowing a business manager to select the best candidate to fill a particular position in the business.

1. A method for comparing candidates for hiring based on an assessment of traits of potential candidates, the method comprising:
coupling a computer processor through a network to individual processors;
accessing assessments through the individual processors to determine an individual's assessment data; and
presenting the assessment data of at least two individuals for comparison.

2. The method of claim 1 further comprising:
generating and displaying assessment data for one candidate in a side by side comparison with another set of assessment data.

3. An apparatus for comparing candidates for hiring comprising:
a computer processor assessing assessment test data;
at least one individual processor coupled through a network to the computer processor; and
a digital display coupled to the at least one individual processor for displaying assessment data of at least two candidates generated by the computer processor.
